(19) United States
(12) Patent Application Publication
(10) Pub. No.: US 2018/0247504 A1
(43) Pub. Date: Aug. 30, 2018

(54) IDENTIFICATION OF SUSPICIOUS PERSONS USING AUDIO/VIDEO RECORDING AND COMMUNICATION DEVICES

(71) Applicant: RING Inc., Santa Monica, CA (US)

(72) Inventors: James Siminoff, Pacific Palisades, CA (US); Michael Jason Mitura, Los Angeles, CA (US)

(21) Appl. No.: 15/905,683

(22) Filed: Feb. 26, 2018

Related U.S. Application Data
(60) Provisional application No. 62/464,342, filed on Feb. 27, 2017.
(60) Provisional application No. 62/517,416, filed on Jun. 9, 2017.

(51) Int. Cl. G08B 13/196; H04N 7/18; G06K 9/00

(52) U.S. Cl. CPC G08B 13/19608; H04N 7/181; G08B 13/19669; G06K 9/00288; G08B 13/19645; G06K 9/00342

(57) ABSTRACT

A first audio/video (A/V) recording and communication device having a first camera with a first field of view and a second A/V recording and communication device having a second camera with a second field of view. A method determines that a person has entered the first field of view, determines that the person has left the first field of view, and determines that the person has entered the second field of view. The method sets a suspicious person warning flag, generates an alert, and transmits the alert to a client device that is associated with the first and second A/V recording and communication devices.

### CROSS-REFERENCE TO RELATED APPLICATIONS

This application claims priority to provisional application Ser. No. 62/464,342, filed on Feb. 27, 2017, and provisional application Ser. No. 62/517,416, filed on Jun. 9, 2017. The entire contents of the priority applications are hereby incorporated by reference in their entireties as if fully set forth.

### TECHNICAL FIELD

The present embodiments relate to audio/video (A/V) recording and communication devices, including A/V recording and communication doorbell systems. In particular, the present embodiments relate to improvements in the functionality of A/V recording and communication devices that strengthen the ability of such devices to identify a person that is exhibiting suspicious behavior, a known criminal, or a person of interest to the owner of the device, and then send alerts to the owner of the device, monitoring services, and/or law enforcement.

### BACKGROUND

Home security is a concern for many homeowners and renters. Those seeking to protect or monitor their homes often wish to have video and audio communications with visitors, for example, those visiting an external door or entryway. Audio/Video (A/V) recording and communication devices, such as doorbells, provide this functionality, and can also aid in crime detection and prevention. For example, audio and/or video captured by an A/V recording and communication device can be uploaded to the cloud and recorded on a remote server. Subsequent review of the A/V footage can aid law enforcement in capturing perpetrators of home burglaries and other crimes. Further, the presence of one or more A/V recording and communication devices on the exterior of a home, such as a doorbell unit at the entrance to the home, acts as a powerful deterrent against would-be burglars.

### SUMMARY

The various embodiments of the present method and system for identification of suspicious persons using audio/video (A/V) recording and communication devices have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the need and ability to recognize suspicious behavior of a person approaching a property (or lingering about a property), and/or the need and ability to recognize the presence of a suspicious person, all without the need for real-time human decision making. Specifically, while a property owner/resident might be able to recognize suspicious behavior or a suspicious person if the property owner/resident is present on a property and observing the potentially suspicious person, these assessments cannot be performed if the property owner/resident is not present, or is not in a position to observe the potentially suspicious person. It would be advantageous, therefore, if the functionality of A/V recording and communication devices could be leveraged to identify a suspicious person from a database of suspicious persons. It would also be advantageous if the functionality of A/V recording and communication devices could be leveraged to identify suspicious behavior, including the presence of a weapon or burglary tool, even if the person performing it is not readily identifiable. The present embodiments provide these advantages and enhancements, as described below.

In a first aspect, a method for identifying suspicious behavior of a person using a first audio/video (A/V) recording and communication device installed at an address, said first device including a first camera with a first field of view, and a second A/V recording and communication device installed at the address, said second device including a second camera with a second field of view, wherein the first A/V recording and communication device, and the second A/V recording and communication device are each in communication with a processor, and the first field of view and the second field of view are not overlapping, is provided, the method comprising determining that a person has entered the first field of view, determining that the person has left the first field of view, determining that the person has entered the second field of view, setting a suspicious person warning flag, generating an alert, and transmitting the alert to a client device associated with the first and second A/V recording and communication devices.

In an embodiment of the first aspect, the first A/V recording and communication device is installed such that the first field of view includes areas that are publicly accessible and the second A/V recording and communication device is installed such that the second field of view only includes areas that are not publicly accessible.

In another embodiment of the first aspect, the method further comprises determining that the person is not in a database of known persons, and setting the suspicious person warning flag only if the person has entered both the first field of view and the second field of view and is not in the database of known persons.

In another embodiment of the first aspect, the method further comprises saving an image of a visitor to the database of known persons.

In another embodiment of the first aspect, wherein determining that the person is not in the database of known persons comprises comparing an image of the person captured by at least one of the first camera while the person is in the first field of view and the second camera while the person is in the second field of view, with the image of the visitor to determine whether the person is the visitor.

In another embodiment of the first aspect, the method further comprises determining that the person is within the second field of view for at least an amount of time, and setting the suspicious person warning flag only if the person has entered both the first field of view and the second field of view and is within the second field of view for at least the amount of time.

In another embodiment of the first aspect, the amount of time is five minutes.

In a second aspect, a method for identifying suspicious behavior of a person using a first audio/video (A/V) recording and communication device installed at a first address, said first device including a first camera with a first field of view, and a second A/V recording and communication device installed at a second address different from the first address, said second device including a second camera with a second field of view, wherein the first A/V recording and communication device and the second A/V recording and communication device are each in communication with a processor, and the first field of view and the second field of view are not overlapping, is provided, the method comprising determining that a person has entered the first field of view, determining that the person has left the first field of view, determining that the person has entered the second field of view, setting a suspicious person warning flag, generating an alert, and transmitting the alert to a client device associated with one of the first and second A/V recording and communication devices.

In an embodiment of the second aspect, wherein the first address and the second address are on the same street.

In another embodiment of the second aspect, wherein the first address and the second address are less than a half-mile apart.

In another embodiment of the second aspect, wherein the first address and the second address are less than one mile apart.

In another embodiment of the second aspect, wherein the client device is a first client device, wherein the method further comprises transmitting the alert to a second client device that is only associated with the first A/V recording and communication device and to a third client device that is only associated with the second A/V recording and communication device.

In another embodiment of the second aspect, the method further comprises determining that the person is not in a database of known persons, and setting the suspicious person warning flag only if the person has entered both the first field of view and the second field of view and is not in the database of known person.

In another embodiment of the second aspect, the method further comprises saving an image of a visitor to the database of known persons, wherein determining that the person is not in the data base of known persons comprises comparing an image of the person captured by at least one of the first camera and the second camera, with the image of the visitor to determine whether the person is the visitor.

In a third aspect, a method for an audio/video (A/V) recording and communication device, the device including a camera and a doorbell, is provided, the method comprising receiving image data of a person within a field of view of the camera, determining, using the image data, whether the person is a suspicious person, wherein the determining comprises using computer vision software to analyze the image data to determine if the person approaches the camera at a run and using computer vision software to analyze the image data to determine if the person then moves away from the camera at a run, upon determining that the person is a suspicious person, generating an alert, and transmitting the alert to a client device associated with the A/V recording and communication device.

In an embodiment of the third aspect, wherein determining whether the person is a suspicious person further comprises using computer vision software to analyze the image data to identify facial characteristics or features sufficient to distinguish the person, comparing the facial characteristics or features of the person to facial characteristics or features in a database containing facial characteristics or features of known suspicious persons, and based on the comparing, determining that the person is either suspicious or not.

In another embodiment of the third aspect, the method further comprises receiving image data of at least one person known to be suspicious by a user of the A/V recording and communication device; and saving the image data of the at least one person in the database.

In another embodiment of the third aspect, wherein determining whether the person is a suspicious person further comprises determining an amount of time in which the person is in the field of view of the camera, determining if the amount of time exceeds a predetermined period of time, and if the amount of time is or exceeds the predetermined period of time, setting a suspicious person warning flag to generate the alert.

In another embodiment of the third aspect, the predetermined period of time is five minutes.

In another embodiment of the third aspect, the method further comprises transmitting the alert to at least one of a public law enforcement agency and a private security company.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The various embodiments of the present parcel theft deterrence for audio/video (A/V) recording and communication devices now will be discussed in detail with an emphasis on highlighting the advantageous features. These embodiments depict the novel and non-obvious audio/video (A/V) recording and communication devices shown in the accompanying drawings, and the methods which can be performed with them, which are for illustrative purposes only. These drawings include the following figures, in which like numerals indicate like parts:

FIG. 1 is a functional block diagram illustrating a system for streaming and storing A/V content captured by an audio/video (A/V) recording and communication device according to various aspects of the present disclosure;

FIG. 2 is a flowchart illustrating a process for streaming and storing A/V content from an A/V recording and communication device according to various aspects of the present disclosure;

FIG. 3 is a functional block diagram illustrating an embodiment of an A/V recording and communication device according to the present disclosure;

FIG. 4 is a front perspective view of an embodiment of an A/V recording and communication device according to the present disclosure;

FIG. 5 is a rear perspective view of the A/V recording and communication device of FIG. 4;

FIG. 6 is a partially exploded front perspective view of the A/V recording and communication device of FIG. 4 showing the cover removed;

FIGS. 7-9 are front perspective views of various internal components of the A/V recording and communication device of FIG. 4;

FIG. 10 is a right-side cross-sectional view of the A/V recording and communication device of FIG. 4 taken through the line 10-10 in FIG. 4;

FIGS. 11-13 are rear perspective views of various internal components of the A/V recording and communication device of FIG. 4;

FIG. 14 is a functional block diagram illustrating a system for communicating in a network according to various aspects of the present disclosure;

FIG. 15 is a flowchart illustrating an embodiment of a process for deterring parcel theft with an A/V recording and communication device according to various aspects of the present disclosure;

FIG. 16 is a sequence diagram illustrating an embodiment of a process for identifying suspicious persons according to various aspects of the present disclosure;

FIG. 17 is a flowchart illustrating an embodiment of a process for determining that unidentified persons are suspicious, according to various aspects of the present disclosure;

FIG. 18 is a flowchart illustrating an embodiment of a process for identifying suspicious behavior by a person, namely the person carrying suspicious objects, according to various embodiments of the present disclosure;

FIG. 19 is a flowchart illustrating an embodiment of a process for identifying suspicious behavior by a person, namely running toward or away from a security camera, according to various embodiments of the present disclosure;

FIG. 20 is a flowchart illustrating an embodiment of a process for identifying a form of suspicious behavior, namely obscuring a person's face from view of the camera, according to various embodiments of the present disclosure;

FIG. 21 is a flowchart illustrating an embodiment of a process for identifying suspicious behavior, namely determining that a person is peering into a window adjacent the camera, according to various embodiments of the present disclosure;

FIG. 22 is a flowchart illustrating an embodiment of a process for identifying suspicious behavior, namely tampering with the security camera, according to various embodiments of the present disclosure;

FIG. 23 is a flowchart illustrating an embodiment of a process for identifying suspicious behavior, namely a suspicious sound, according to various embodiments of the present disclosure;

FIG. 24 is a flowchart illustrating an embodiment of a process for identifying suspicious behavior, namely determining that an unauthorized person has approached an expensive item of collateral, according to various embodiments of the present disclosure;

FIG. 25 is a flowchart illustrating an embodiment of a process for identifying suspicious behavior, and then confirming that with a registered user;

FIG. 26 is a functional block diagram of a client device on which the present embodiments may be implemented according to various aspects of the present disclosure; and

FIG. 27 is a functional block diagram of a general-purpose computing system on which the present embodiments may be implemented according to various aspects of present disclosure.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features. Whenever the shapes, relative positions and other aspects of the parts described in the embodiments are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

The embodiments of the present method and system for identification of suspicious persons and suspicious behavior, using audio/video (A/V) recording and communication devices are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

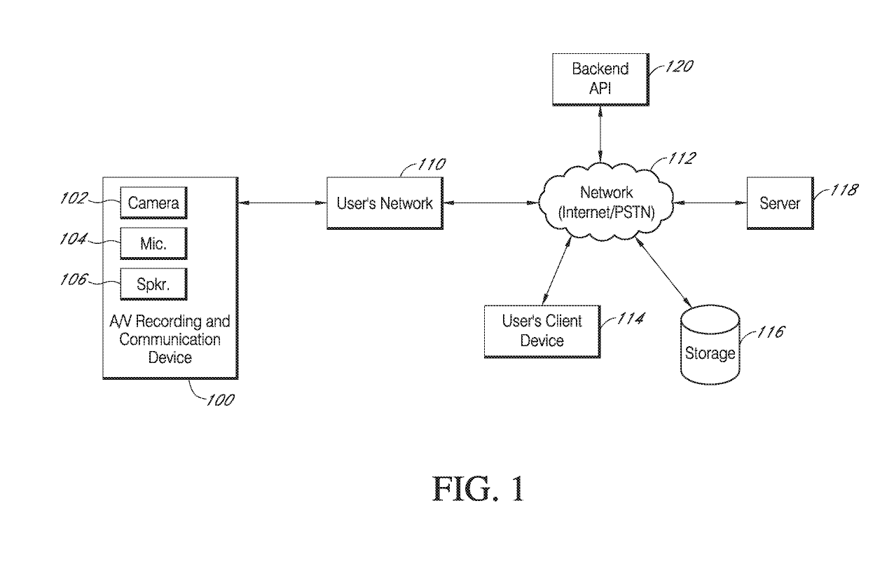

With reference to FIG. 1, the present embodiments include an audio/video (A/V) device 100, such as a doorbell. While the present disclosure provides numerous examples of methods and systems including A/V recording and communication doorbells, the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and functionality of the doorbells described herein, but without the front button and related components.

The A/V recording and communication device 100 may be located near the entrance to a structure (not shown), such as a dwelling, a business, a storage facility, etc. The A/V recording and communication device 100 includes a camera 102, a microphone 104, and a speaker 106. The camera 102 may comprise, for example, a high definition (HD) video camera, such as one capable of capturing video images at an image display resolution of 720p, or 1080p, or better. While not shown, the A/V recording and communication device 100 may also include other hardware and/or components, such as a housing, one or more motion sensors (and/or other types of sensors), a button, etc. The A/V recording and communication device 100 may further include similar componentry and/or functionality as the wireless communication doorbells described in US Patent Application Publication Nos. 2015/0022620 (application Ser. No. 14/499,828) and 2015/0022618 (application Ser. No. 14/334,922), both of which are incorporated herein by reference in their entireties as if fully set forth.

With further reference to FIG. 1, the A/V recording and communication device 100 communicates with a user's network 110, which may be for example a wired and/or wireless network. If the user's network 110 is wireless, or includes a wireless component, the network 110 may be a Wi-Fi network compatible with the IEEE 802.11 standard and/or other wireless communication standard(s). The user's network 110 is connected to another network 112, which may comprise, for example, the Internet and/or a public switched telephone network (PSTN). As described below, the A/V recording and communication device 100 may communicate with the user's client device 114 via the network 110 and the network 112 (Internet/PSTN). The user's client device 114 may comprise, for example, a mobile telephone (may also be referred to as a cellular telephone), such as a smartphone, a personal digital assistant (PDA), or another communication device. The user's client device 114 comprises a display (not shown) and related components capable of displaying streaming and/or recorded video images. The user's client device 114 may also comprise a speaker and related components capable of broadcasting streaming and/or recorded audio, and may also comprise a microphone. The A/V recording and communication device 100 may also communicate with one or more remote storage device(s) 116 (may be referred to interchangeably as “cloud storage device(s)”), one or more servers 118, and/or a backend API (application programming interface) 120 via the network 110 and the network 112 (Internet/PSTN). While FIG. 1 illustrates the storage device 116, the server 118, and the backend API 120 as components separate from the network 112, it is to be understood that the storage device 116, the server 118, and/or the backend API 120 may be considered to be components of the network 112 (Internet/PSTN).

The network 112 (Internet/PSTN) may be any wireless network or any wired network, or a combination thereof, configured to operatively couple the above-mentioned modules, devices, and systems as shown in FIG. 1. For example, the network 112 (Internet/PSTN)_may include one or more of the following: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), LTE, VoLTE, LoRaWAN, LPWAN, RPMA, LTE Cat-“X” (e.g. LTE Cat 1, LTE Cat 0, LTE CatM1, LTE Cat NB1), CDMA (Code Division Multiple Access), TDMA (Time Division Multiple Access), FDMA (Frequency Division Multiple Access), and/or OFDMA (Orthogonal Frequency Division Multiple Access) cellular phone networks, GPS, CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-1394 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking.

According to one or more aspects of the present embodiments, when a person (may be referred to interchangeably as “visitor”) arrives at the A/V recording and communication device 100, the A/V recording and communication device 100 detects the visitor's presence and begins capturing video images within a field of view of the camera 102. The A/V communication device 100 may also capture audio through the microphone 104. The A/V recording and communication device 100 may detect the visitor's presence using a motion sensor, and/or by detecting that the visitor has depressed the button on the A/V recording and communication device 100.

In response to the detection of the visitor, the A/V recording and communication device 100 sends an alert to the user's client device 114 (FIG. 1) via the user's network 110 and the network 112 (Internet/PSTN). The A/V recording and communication device 100 also sends streaming video, and may also send streaming audio, to the user's client device 114. If the user answers the alert, two-way audio communication may then occur between the visitor and the user through the A/V recording and communication device 100 and the user's client device 114. The user may view the visitor throughout the duration of the call, but the visitor cannot see the user (unless the A/V recording and communication device 100 includes a display, which it may in some embodiments).

The video images captured by the camera 102 of the A/V recording and communication device 100 (and the audio captured by the microphone 104) may be uploaded to the cloud and recorded on the remote storage device 116 (FIG. 1). In some embodiments, the video and/or audio may be recorded on the remote storage device 116 even if the user chooses to ignore the alert sent to his or her client device 114.

With further reference to FIG. 1, the system may further comprise a backend API 120 including one or more components. A backend API (application programming interface) may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, or database layers, or other components. A backend API may, for example, comprise many such applications, each of which communicate with one another using their public APIs. In some embodiments, the API backend may hold the bulk of the user data and offer the user management capabilities, leaving the clients to have very limited state.

The backend API 120 illustrated FIG. 1 may include one or more APIs. An API is a set of routines, protocols, and tools for building software and applications. An API expresses a software component in terms of its operations, inputs, outputs, and underlying types, defining functionalities that are independent of their respective implementations, which allows definitions and implementations to vary without compromising the interface. Advantageously, an API may provide a programmer with access to an application's functionality without the programmer needing to modify the application itself, or even understand how the application works. An API may be for a web-based system, an operating system, or a database system, and it provides facilities to develop applications for that system using a given programming language. In addition to accessing databases or computer hardware like hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications.

The backend API 120 illustrated in FIG. 1 may further include one or more services (also referred to as network services). A network service is an application that provides data storage, manipulation, presentation, communication, and/or other capability. Network services are often implemented using a client-server architecture based on application-layer network protocols. Each service may be provided by a server component running on one or more computers (such as a dedicated server computer offering multiple services) and accessed via a network by client components running on other devices. However, the client and server components can both be run on the same machine. Clients and servers may have a user interface, and sometimes other hardware associated with them.

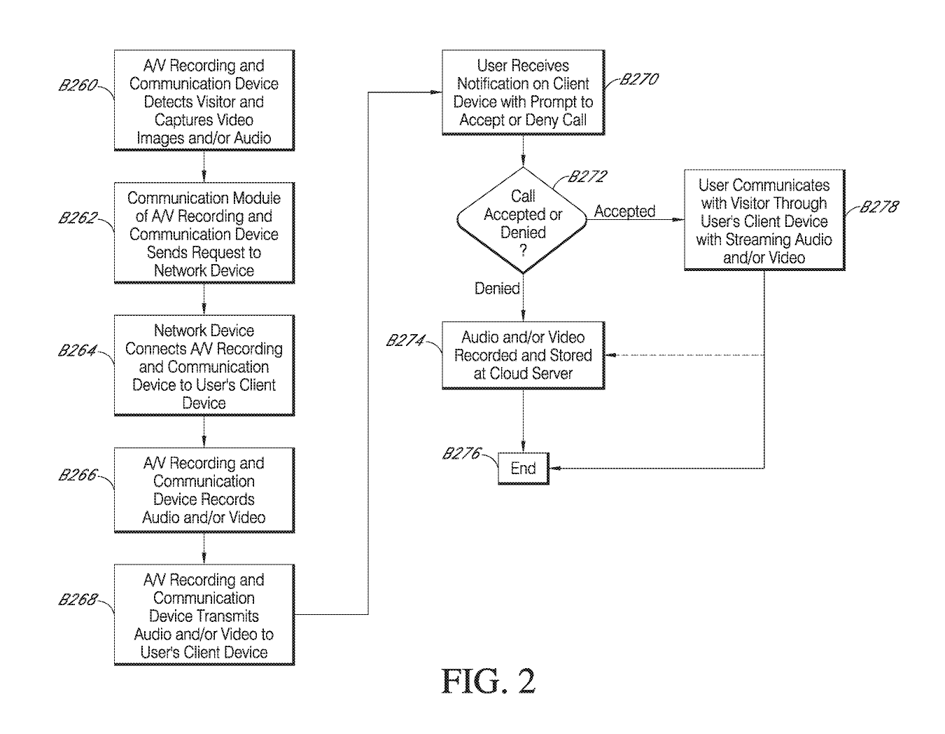

FIG. 2 is a flowchart illustrating a process for streaming and storing A/V content from the A/V recording and communication device 100 according to various aspects of the present disclosure. At block B260, the A/V recording and communication device 100 detects the visitor's presence and captures video images within a field of view of the camera 102. The A/V recording and communication device 100 may also capture audio through the microphone 104. As described above, the A/V recording and communication device 100 may detect the visitor's presence by detecting motion using the camera 102 and/or a motion sensor, and/or by detecting that the visitor has pressed a front button of the A/V recording and communication device 100 (if the A/V recording and communication device 100 is a doorbell). Also, as described above, the video recording/capture may begin when the visitor is detected, or may begin earlier, as described below.

At block B262, a communication module of the A/V recording and communication device 100 sends a request, via the user's network 110 and the network 112 (Internet/PSTN), to a device in the network 112 (Internet/PSTN). For example, the network device to which the request is sent may be a server such as the server 118. The server 118 may comprise a computer program and/or a machine that waits for requests from other machines or software (clients) and responds to them. A server typically processes data. One purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes. In another example, the network device to which the request is sent may be an API such as the backend API 120, which is described above.

In response to the request, at block B264 the network device may connect the A/V recording and communication device 100 to the user's client device 114 through the user's network 110 and the network 112 (Internet/PSTN). At block B266, the A/V recording and communication device 100 may record available audio and/or video data using the camera 102, the microphone 104, and/or any other device/sensor available. At block B268, the audio and/or video data is transmitted (streamed) from the A/V recording and communication device 100 to the user's client device 114 via the user's network 110 and the network 112 (Internet/PSTN). At block B270, the user may receive a notification on his or her user's client device 114 with a prompt to either accept or deny the call.

At block B272, the process determines whether the user has accepted or denied the call. If the user denies the notification, then the process advances to block B274, where the audio and/or video data is recorded and stored at a cloud server. The session then ends at block B276 and the connection between the A/V recording and communication device 100 and the user's client device 114 is terminated. If, however, the user accepts the notification, then at block B278 the user communicates with the visitor through the user's client device 114 while audio and/or video data captured by the camera 102, the microphone 104, and/or other devices/sensors is streamed to the user's client device 114. At the end of the call, the user may terminate the connection between the user's client device 114 and the A/V recording and communication device 100 and the session ends at block B276. In some embodiments, the audio and/or video data may be recorded and stored at a cloud server (block B274) even if the user accepts the notification and communicates with the visitor through the user's client device 114.

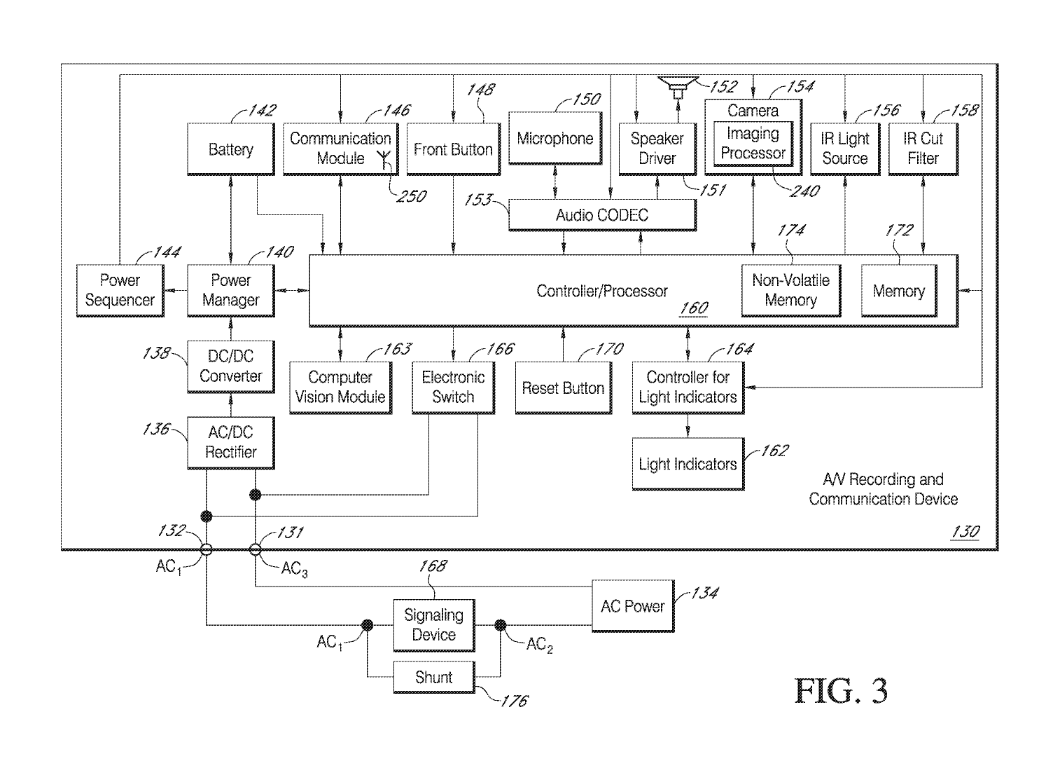

FIGS. 3-13 illustrate one embodiment of a low-power-consumption A/V recording and communication device 130 according to various aspects of the present disclosure. FIG. 3 is a functional block diagram illustrating various components of the A/V recording and communication device 130 and their relationships to one another. For example, the A/V recording and communication device 130 includes a pair of terminals 131, 132 configured to be connected to a source of external AC (alternating-current) power, such as a household AC power supply 134 (may also be referred to as AC mains). The AC power 134 may have a voltage in the range of 16-24 VAC, for example. The incoming AC power 134 may be converted to DC (direct-current) by an AC/DC rectifier 136. An output of the AC/DC rectifier 136 may be connected to an input of a DC/DC converter 138, which may step down the voltage from the output of the AC/DC rectifier 136 from 16-24 VDC to a lower voltage of about 5 VDC, for example. In various embodiments, the output of the DC/DC converter 138 may be in a range of from about 2.5 V to about 7.5 V, for example.

With further reference to FIG. 3, the output of the DC/DC converter 138 is connected to a power manager 140, which may comprise an integrated circuit including a processor core, memory, and/or programmable input/output peripherals. In one non-limiting example, the power manager 140 may be an off-the-shelf component, such as the BQ24773 chip manufactured by Texas Instruments. As described in detail below, the power manager 140 controls, among other things, an amount of power drawn from the external AC power supply 134, as well as an amount of supplemental power drawn from a battery 142, to power the A/V recording and communication device 130. The power manager 140 may, for example, limit the amount of power drawn from the external AC power supply 134 so that a threshold power draw is not exceeded. In one non-limiting example, the threshold power, as measured at the output of the DC/DC converter 138, may be equal to 1.4 A. The power manager 140 may also control an amount of power drawn from the external AC power supply 134 and directed to the battery 142 for recharging of the battery 142. An output of the power manager 140 is connected to a power sequencer 144, which controls a sequence of power delivery to other components of the A/V recording and communication device 130, including a communication module 146, a front button 148, a microphone 150, a speaker driver 151, a speaker 152, an audio CODEC (Coder-DECoder) 153, a camera 154, an infrared (IR) light source 156, an IR cut filter 158, a processor 160 (may also be referred to as a controller 160), a plurality of light indicators 162, and a controller 164 for the light indicators 162. Each of these components is described in detail below. The power sequencer 144 may comprise an integrated circuit including a processor core, memory, and/or programmable input/output peripherals. In one non-limiting example, the power sequencer 144 may be an off-the-shelf component, such as the RT5024 chip manufactured by Richtek.

With further reference to FIG. 3, the A/V recording and communication device 130 further comprises an electronic switch 166 that closes when the front button 148 is depressed. When the electronic switch 166 closes, power from the AC power source 134 is diverted through a signaling device 168 that is external to the A/V recording and communication device 130 to cause the signaling device 168 to emit a sound, as further described below. In one non-limiting example, the electronic switch 166 may be a triac device. The A/V recording and communication device 130 further comprises a reset button 170 configured to initiate a hard reset of the processor 160, as further described below.

With further reference to FIG. 3, the processor 160 may perform data processing and various other functions, as described below. The processor 160 may comprise an integrated circuit including a processor core, memory 172, non-volatile memory 174, and/or programmable input/output peripherals (not shown). The memory 172 may comprise, for example, DDR3 (double data rate type three synchronous dynamic random-access memory). The non-volatile memory 174 may comprise, for example, NAND flash memory. In the embodiment illustrated in FIG. 3, the memory 172 and the non-volatile memory 174 are illustrated within the box representing the processor 160. It is to be understood that the embodiment illustrated in FIG. 3 is merely an example, and in some embodiments the memory 172 and/or the non-volatile memory 174 are not necessarily physically incorporated with the processor 160. The memory 172 and/or the non-volatile memory 174, regardless of their physical location, may be shared by one or more other components (in addition to the processor 160) of the present A/V recording and communication device 130.

The transfer of digital audio between the user and a visitor may be compressed and decompressed using the audio CODEC 153, which is operatively coupled to the processor 160. When the visitor speaks, audio from the visitor is compressed by the audio CODEC 153, digital audio data is sent through the communication module 146 to the network 112 (Internet/PSTN) via the user's network 110, routed by the server 118 and delivered to the user's client device 114. When the user speaks, after being transferred through the network 112 (Internet/PSTN), the user's network 110, and the communication module 146, the digital audio data is decompressed by the audio CODEC 153 and emitted to the visitor through the speaker 152, which is driven by the speaker driver 151.

With further reference to FIG. 3, some of the present embodiments may include a shunt 176 connected in parallel with the signaling device 168. The shunt 176 facilitates the ability of the A/V recording and communication device 130 to draw power from the AC power source 134 without inadvertently triggering the signaling device 168. The shunt 176, during normal standby operation, presents a relatively low electrical impedance, such as a few ohms, across the terminals of the signaling device 168. Most of the current drawn by the A/V recording and communication device 130, therefore, flows through the shunt 176, and not through the signaling device 168. The shunt 176, however, contains electronic circuitry (described below) that switches the shunt 176 between a state of low impedance, such as a few ohms, for example, and a state of high impedance, such as >1K ohms, for example. When the front button 148 of the A/V recording and communication device 130 is pressed, the electronic switch 166 closes, causing the voltage from the AC power source 134 to be impressed mostly across the shunt 176 and the signaling device 168 in parallel, while a small amount of voltage, such as about 1V, is impressed across the electronic switch 166. The circuitry in the shunt 176 senses this voltage, and switches the shunt 176 to the high impedance state, so that power from the AC power source 134 is diverted through the signaling device 168. The diverted AC power 134 is above the threshold necessary to cause the signaling device 168 to emit a sound. Pressing the front button 148 of the device 130 therefore causes the signaling device 168 to “ring,” alerting any person(s) within the structure to which the device 130 is mounted that there is a visitor at the front door (or at another location corresponding to the location of the device 130). In one non-limiting example, the electronic switch 166 may be a triac device.

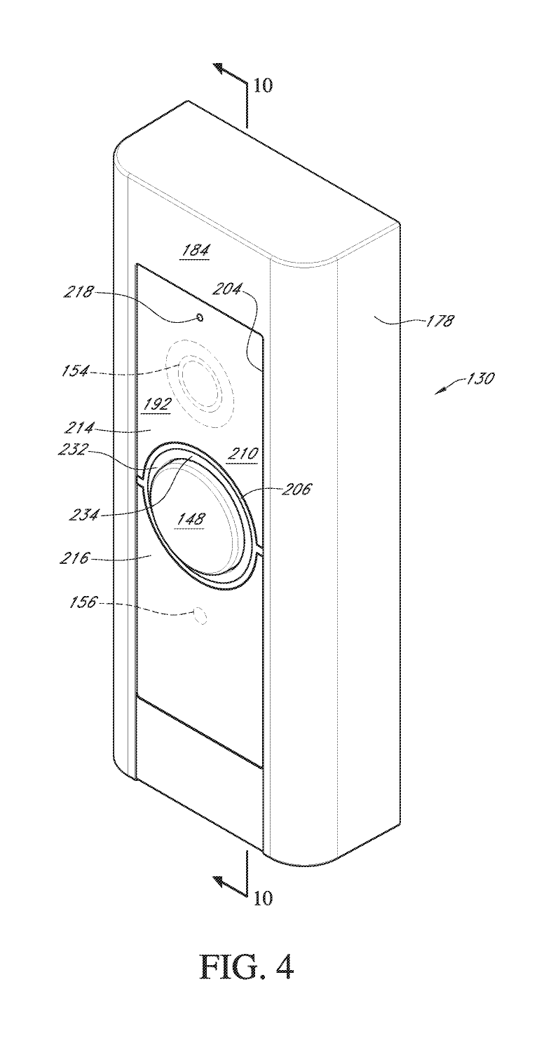

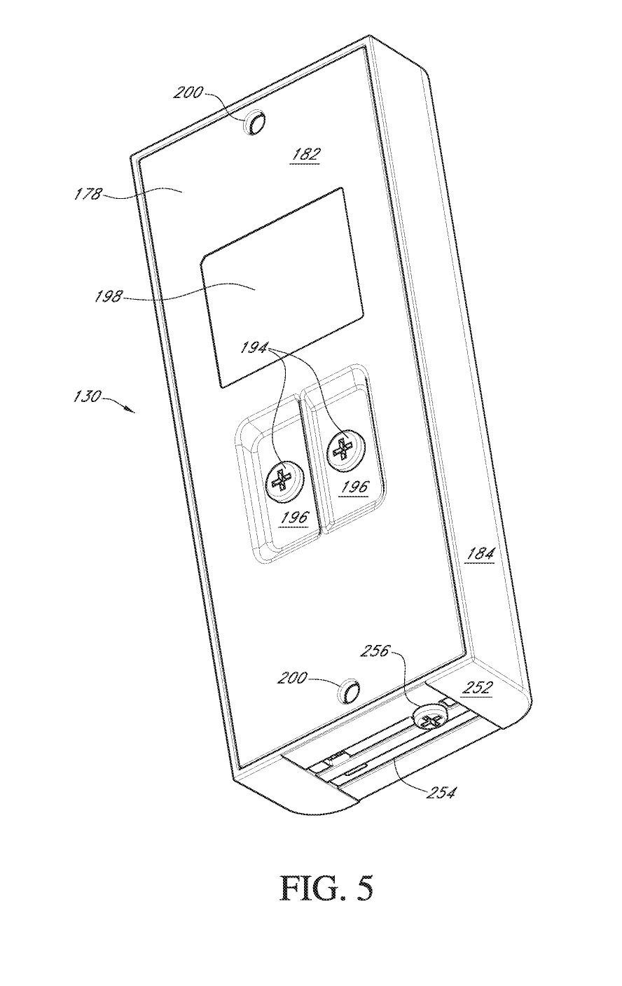

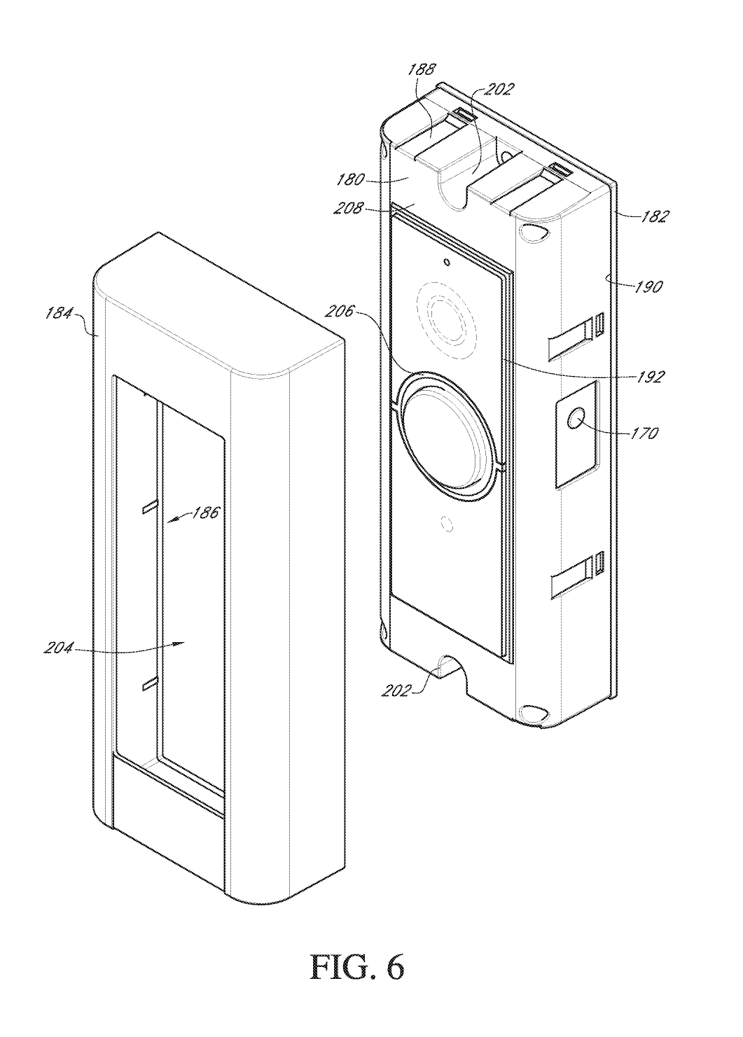

With reference to FIGS. 4-6, the A/V recording and communication device 130 further comprises a housing 178 having an enclosure 180 (FIG. 6), a back plate 182 secured to the rear of the enclosure 180, and a shell 184 overlying the enclosure 180. With reference to FIG. 6, the shell 184 includes a recess 186 that is sized and shaped to receive the enclosure 180 in a close fitting engagement, such that outer surfaces of the enclosure 180 abut conforming inner surfaces of the shell 184. Exterior dimensions of the enclosure 180 may be closely matched with interior dimensions of the shell 184 such that friction maintains the shell 184 about the enclosure 180. Alternatively, or in addition, the enclosure 180 and/or the shell 184 may include mating features 188, such as one or more tabs, grooves, slots, posts, etc. to assist in maintaining the shell 184 about the enclosure 180. The back plate 182 is sized and shaped such that the edges of the back plate 182 extend outward from the edges of the enclosure 180, thereby creating a lip 190 against which the shell 184 abuts when the shell 184 is mated with the enclosure 180, as shown in FIGS. 4 and 5. In some embodiments, multiple shells 184 in different colors may be provided so that the end user may customize the appearance of his or her A/V recording and communication device 130. For example, the A/V recording and communication device 130 may be packaged and sold with multiple shells 184 in different colors in the same package.

With reference to FIG. 4, a front surface of the A/V recording and communication device 130 includes the button 148 (may also be referred to as front button 148, FIG. 3), which is operatively connected to the processor 160. In a process similar to that described above with reference to FIG. 2, when a visitor presses the front button 148 (FIG. 3), an alert may be sent to the user's client device to notify the user that someone is at his or her front door (or at another location corresponding to the location of the A/V recording and communication device 130). With further reference to FIG. 4, the A/V recording and communication device 130 further includes the camera 154, which is operatively connected to the processor 160, and which is located behind a shield 192 (FIG. 6). As described in detail below, the camera 154 is configured to capture video images from within its field of view. Those video images can be streamed to the user's client device and/or uploaded to a remote network device for later viewing according to a process similar to that described above with reference to FIG. 2.

With reference to FIG. 5, a pair of terminal screws 194 extends through the back plate 182. The terminal screws 194 are connected at their inner ends to the terminals 131, 132 (FIG. 3) within the A/V recording and communication device 130. The terminal screws 194 are configured to receive electrical wires to connect to the A/V recording and communication device 130, through the terminals 131, 132, to the household AC power supply 134 of the structure on which the A/V recording and communication device 130 is mounted. In the illustrated embodiment, the terminal screws 194 are located within a recessed portion 196 of the rear surface 198 of the back plate 182 so that the terminal screws 194 do not protrude from the outer envelope of the A/V recording and communication device 130. The A/V recording and communication device 130 can thus be mounted to a mounting surface with the rear surface 198 of the back plate 182 abutting the mounting surface. The back plate 182 includes apertures 200 adjacent its upper and lower edges to accommodate mounting hardware, such as screws (not shown), for securing the back plate 182 (and thus the A/V recording and communication device 130) to the mounting surface. With reference to FIG. 6, the enclosure 180 includes corresponding apertures 202 adjacent its upper and lower edges that align with the apertures 200 in the back plate 182 to accommodate the mounting hardware. In certain embodiments, the A/V recording and communication device 130 may include a mounting plate or bracket (not shown) to facilitate securing the A/V recording and communication device 130 to the mounting surface.

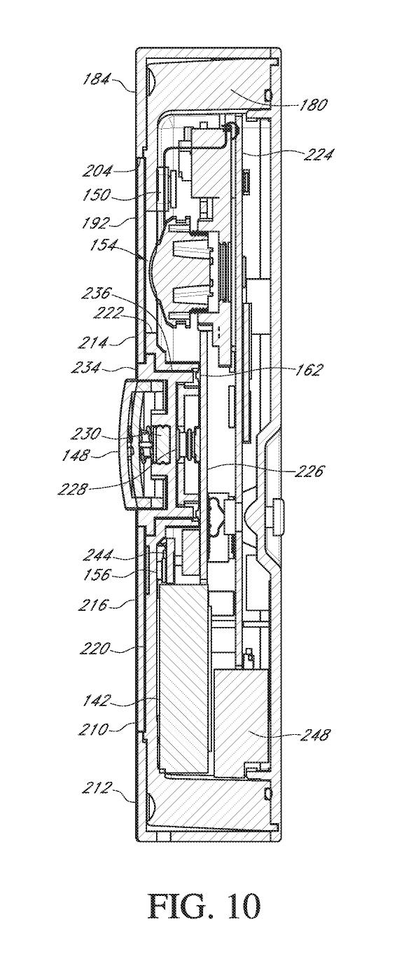

With further reference to FIG. 6, the shell 184 includes a central opening 204 in a front surface. The central opening 204 is sized and shaped to accommodate the shield 192. In the illustrated embodiment, the shield 192 is substantially rectangular, and includes a central opening 206 through which the front button 148 protrudes. The shield 192 defines a plane parallel to and in front of a front surface 208 of the enclosure 180. When the shell 184 is mated with the enclosure 180, as shown in FIGS. 4 and 10, the shield 192 resides within the central opening 204 of the shell 184 such that a front surface 210 of the shield 192 is substantially flush with a front surface 212 of the shell 184 and there is little or no gap (FIG. 4) between the outer edges of the shield 192 and the inner edges of the central opening 204 in the shell 184.

With further reference to FIG. 6, the shield 192 includes an upper portion 214 (located above and to the sides of the front button 148) and a lower portion 216 (located below and to the sides of the front button 148). The upper and lower portions 214, 216 of the shield 192 may be separate pieces, and may comprise different materials. The upper portion 214 of the shield 192 may be transparent or translucent so that it does not interfere with the field of view of the camera 154. For example, in certain embodiments the upper portion 214 of the shield 192 may comprise glass or plastic. As described in detail below, the microphone 150, which is operatively connected to the processor 160, is located behind the upper portion 214 of the shield 192. The upper portion 214, therefore, may include an opening 218 that facilitates the passage of sound through the shield 192 so that the microphone 150 is better able to pick up sounds from the area around the A/V recording and communication device 130.

The lower portion 216 of the shield 192 may comprise a material that is substantially transparent to infrared (IR) light, but partially or mostly opaque with respect to light in the visible spectrum. For example, in certain embodiments the lower portion 216 of the shield 192 may comprise a plastic, such as polycarbonate. The lower portion 216 of the shield 192, therefore, does not interfere with transmission of IR light from the IR light source 156, which is located behind the lower portion 216. As described in detail below, the IR light source 156 and the IR cut filter 158, which are both operatively connected to the processor 160, facilitate “night vision” functionality of the camera 154.

The upper portion 214 and/or the lower portion 216 of the shield 192 may abut an underlying cover 220 (FIG. 10), which may be integral with the enclosure 180 or may be a separate piece. The cover 220, which may be opaque, may include a first opening 222 corresponding to the location of the camera 154, a second opening (not shown) corresponding to the location of the microphone 150 and the opening 218 in the upper portion 214 of the shield 192, and a third opening (not shown) corresponding to the location of the IR light source 156.

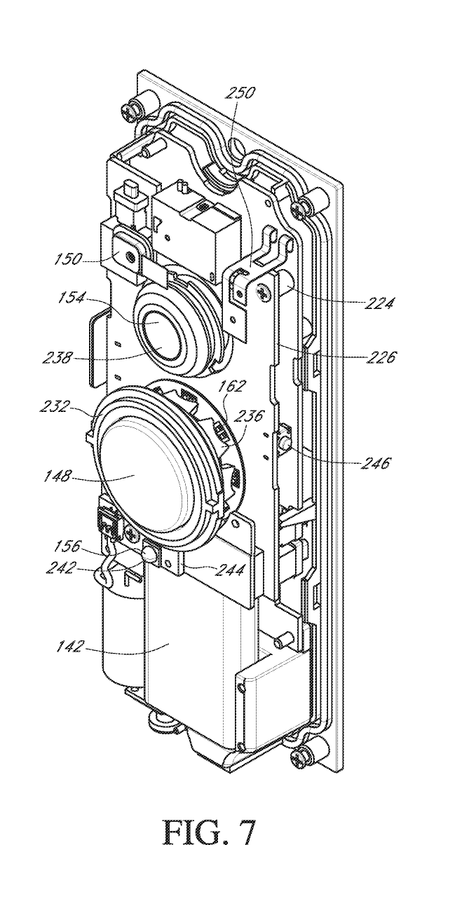

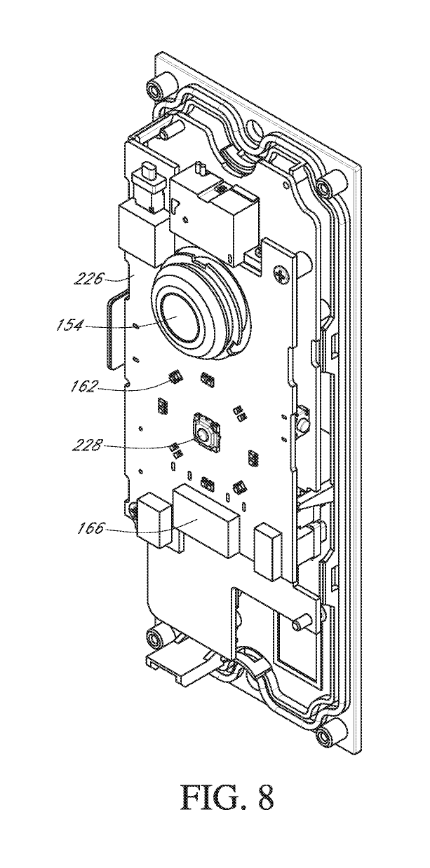

FIGS. 7-10 illustrate various internal components of the A/V recording and communication device 130. FIGS. 7-9 are front perspective views of the device 130 with the shell 184 and the enclosure 180 removed, while FIG. 10 is a right-side cross-sectional view of the device 130 taken through the line 10-10 in FIG. 4. With reference to FIGS. 7 and 8, the A/V recording and communication device 130 further comprises a main printed circuit board (PCB) 224 and a front PCB 226. With reference to FIG. 8, the front PCB 226 comprises a button actuator 228. With reference to FIGS. 7, 8, and 10, the front button 148 is located in front of the button actuator 228. The front button 148 includes a stem 230 (FIG. 10) that extends into the housing 178 to contact the button actuator 228. When the front button 148 is pressed, the stem 230 depresses the button actuator 228, thereby closing the electronic switch 166 (FIG. 8), as described below.

With reference to FIG. 8, the front PCB 226 further comprises the light indicators 162, which may illuminate when the front button 148 of the device 130 is pressed. In the illustrated embodiment, the light indicators 162 comprise light-emitting diodes (LEDs 162) that are surface mounted to the front surface of the front PCB 226 and are arranged in a circle around the button actuator 228. The present embodiments are not limited to the light indicators 162 being LEDs, and in alternative embodiments the light indicators 162 may comprise any other type of light-emitting device. The present embodiments are also not limited by the number of light indicators 162 shown in FIG. 8, nor by the pattern in which they are arranged.

With reference to FIG. 7, the device 130 further comprises a light pipe 232. The light pipe 232 is a transparent or translucent ring that encircles the front button 148. With reference to FIG. 4, the light pipe 232 resides in an annular space between the front button 148 and the central opening 206 in the shield 192, with a front surface 234 of the light pipe 232 being substantially flush with the front surface 210 of the shield 192. With reference to FIGS. 7 and 10, a rear portion of light pipe 232 includes a plurality of posts 236 whose positions correspond to the positions of the LEDs 162. When the LEDs 162 are illuminated, light is transmitted through the posts 236 and the body of the light pipe 232 so that the light is visible at the front surface 234 of the light pipe 232. The LEDs 162 and the light pipe 232 thus provide a ring of illumination around the front button 148. The light pipe 232 may comprise a plastic, for example, or any other suitable material capable of transmitting light.

The LEDs 162 and the light pipe 232 may function as visual indicators for a visitor and/or a user. For example, the LEDs 162 may illuminate upon activation or stay illuminated continuously. In one aspect, the LEDs 162 may change color to indicate that the front button 148 has been pressed. The LEDs 162 may also indicate that the battery 142 needs recharging, or that the battery 142 is currently being charged, or that charging of the battery 142 has been completed. The LEDs 162 may indicate that a connection to the user's wireless network is good, limited, poor, or not connected. The LEDs 162 may be used to guide the user through setup or installation steps using visual cues, potentially coupled with audio cues emitted from the speaker 152.

With further reference to FIG. 7, the A/V recording and communication device 130 further comprises a rechargeable battery 142. As described in further detail below, the A/V recording and communication device 130 is connected to an external power source 134 (FIG. 3), such as AC mains. The A/V recording and communication device 130 is primarily powered by the external power source 134, but may also draw power from the rechargeable battery 142 so as not to exceed a threshold amount of power from the external power source 134, to thereby avoid inadvertently sounding the signaling device 168. With reference to FIG. 3, the battery 142 is operatively connected to the power manager 140. As described below, the power manager 140 controls an amount of power drawn from the battery 142 to supplement the power drawn from the external AC power source 134 to power the A/V recording and communication device 130 when supplemental power is needed. The power manager 140 also controls recharging of the battery 142 using power drawn from the external power source 134. The battery 142 may comprise, for example, a lithium-ion battery, or any other type of rechargeable battery.

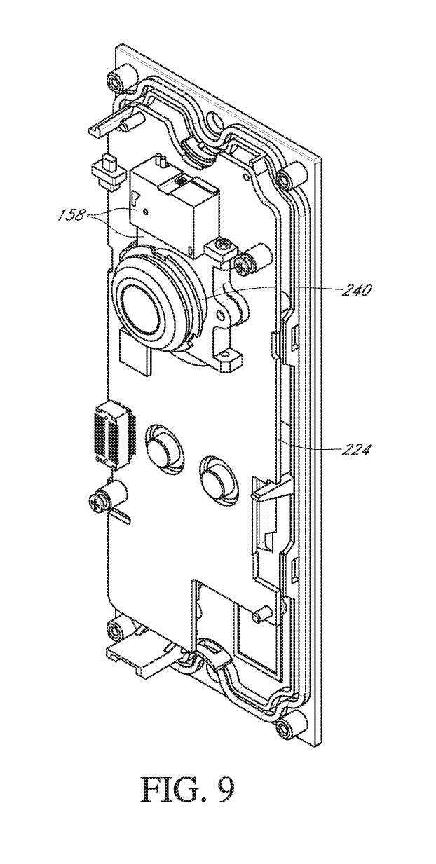

With further reference to FIG. 7, the A/V recording and communication device 130 further comprises the camera 154. The camera 154 is coupled to a front surface of the front PCB 226, and includes a lens 238 and an imaging processor 240 (FIG. 9). The camera lens 238 may be a lens capable of focusing light into the camera 154 so that clear images may be captured. The camera 154 may comprise, for example, a high definition (HD) video camera, such as one capable of capturing video images at an image display resolution of 720p or better. In certain of the present embodiments, the camera 154 may be used to detect motion within its field of view, as described below.

With further reference to FIG. 7, the A/V recording and communication device 130 further comprises an infrared (IR) light source 242. In the illustrated embodiment, the IR light source 242 comprises an IR light-emitting diode (LED) 242 coupled to an IR LED printed circuit board (PCB) 244. In alternative embodiments, the IR LED 242 may not comprise a separate PCB 244, and may, for example, be coupled to the front PCB 226.

With reference to FIGS. 7 and 10, the IR LED PCB 244 is located below the front button 148 (FIG. 7) and behind the lower portion 216 of the shield 192 (FIG. 10). As described above, the lower portion 216 of the shield 192 is transparent to IR light, but may be opaque with respect to light in the visible spectrum. In alternative embodiments of the IR LED PCB 244, the IR LED PCB 244 may include more than one IR LED 242. For example, the IR LED PCB 244 may include three IR LEDs 242, or any other number of IR LEDs 242. In embodiments including more than one IR LED 242, the size of the third opening in the cover may be increased to accommodate the larger size of the IR LED PCB 244.

The IR LED 242 may be triggered to activate when a low level of ambient light is detected. When activated, IR light emitted from the IR LED 242 illuminates the camera 154's field of view. The camera 154, which may be configured to detect IR light, may then capture the IR light emitted by the IR LED 242 as it reflects off objects within the camera 154's field of view, so that the A/V recording and communication device 130 can clearly capture images at night (may be referred to as “night vision”).

With reference to FIG. 9, the A/V recording and communication device 130 further comprises an IR cut filter 158. The IR cut filter 158 is a mechanical shutter that can be selectively positioned between the lens 238 and the image sensor of the camera 154. During daylight hours, or whenever there is a sufficient amount of ambient light, the IR cut filter 158 is positioned between the lens 238 and the image sensor to filter out IR light so that it does not distort the colors of images as the human eye sees them. During nighttime hours, or whenever there is little to no ambient light, the IR cut filter 158 is withdrawn from the space between the lens 238 and the image sensor, so that the camera 154 is sensitive to IR light (“night vision”). In some embodiments, the camera 154 acts as a light detector for use in controlling the current state of the IR cut filter 158 and turning the IR LED 242 on and off. Using the camera 154 as a light detector is facilitated in some embodiments by the fact that the A/V recording and communication device 130 is powered by a connection to AC mains, and the camera 154, therefore, is always powered on. In other embodiments, however, the A/V recording and communication device 130 may include a light sensor separate from the camera 154 for use in controlling the IR cut filter 158 and the IR LED 242.

With reference back to FIG. 6, the A/V recording and communication device 130 further comprises a reset button 170. The reset button 170 contacts a reset button actuator 246 (FIG. 8) coupled to the front PCB 226. When the reset button 170 is pressed, it may contact the reset button actuator 246, which may trigger the erasing of any data stored at the non-volatile memory 174 and/or at the memory 172 (FIG. 3), and/or may trigger a reboot of the processor 160. In some embodiments, the reset button 170 may also be used in a process to activate the A/V recording and communication device 130, as described below.

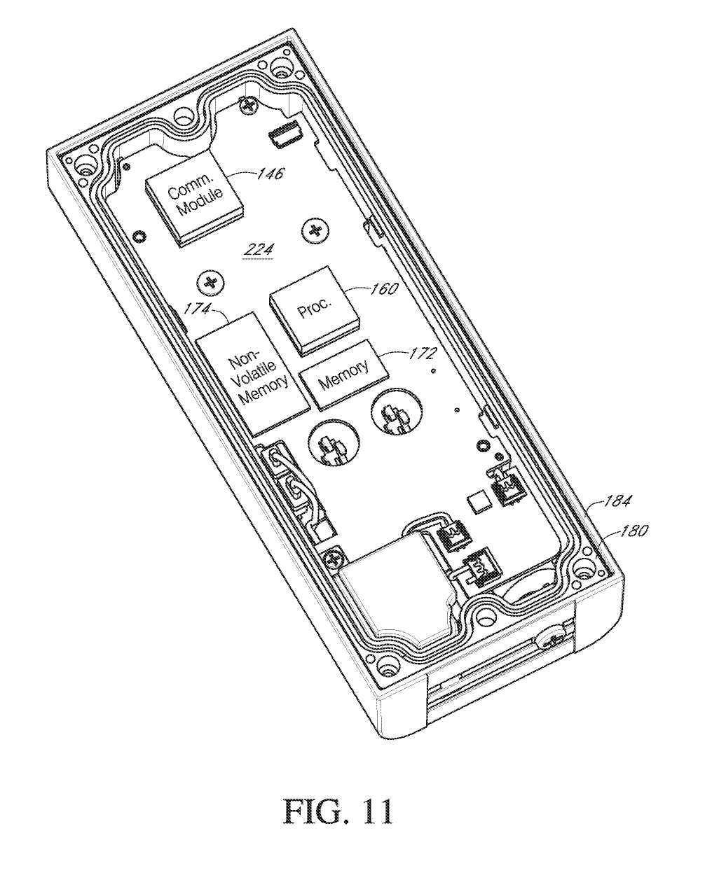

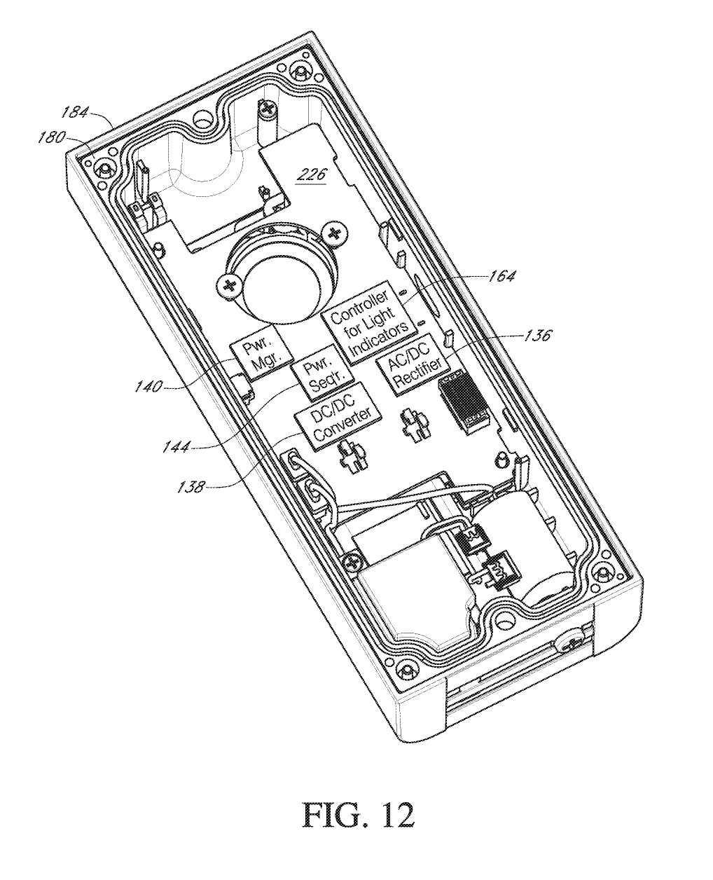

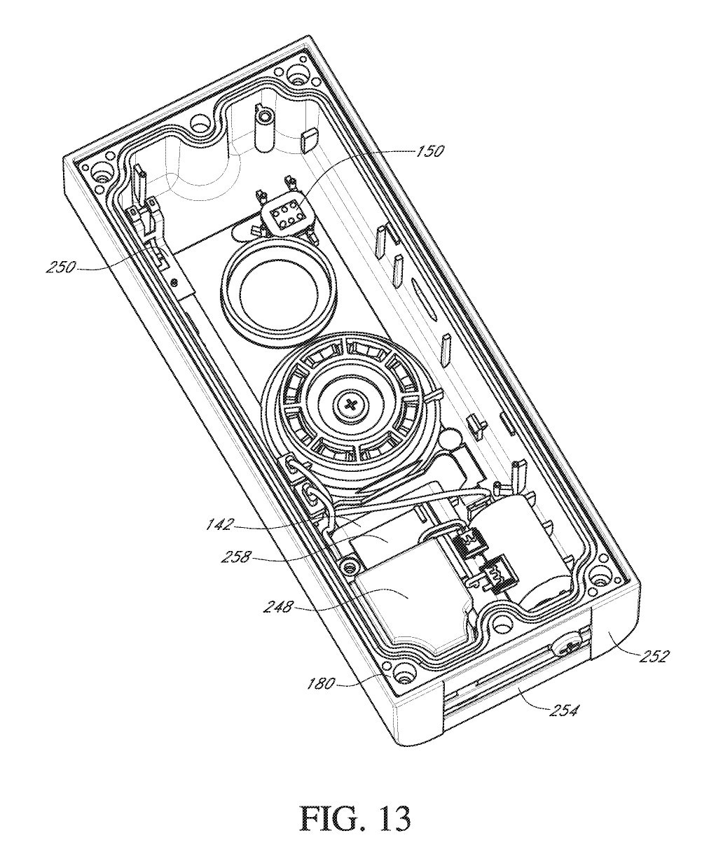

FIGS. 11-13 further illustrate internal components of the A/V recording and communication device 130. FIGS. 11-13 are rear perspective views of the device 130 with the back plate 182 and additional components removed. For example, in FIG. 11 the back plate 182 is removed, while in FIG. 12 the back plate 182 and the main PCB 224 are removed, and in FIG. 13 the back plate 182, the main PCB 224, and the front PCB 226 are removed. With reference to FIG. 11, several components are coupled to the rear surface of the main PCB 224, including the communication module 146, the processor 160, memory 172, and non-volatile memory 174. The functions of each of these components are described below. With reference to FIG. 12, several components are coupled to the rear surface of the front PCB 226, including the power manager 140, the power sequencer 144, the AC/DC rectifier 136, the DC/DC converter 138, and the controller 164 for the light indicators 162. The functions of each of these components are also described below. With reference to FIG. 13, several components are visible within the enclosure 180, including the microphone 150, a speaker chamber 248 (in which the speaker 152 is located), and an antenna 250 for the communication module 146. The functions of each of these components are also described below.

With reference to FIG. 7, the antenna 250 is coupled to the front surface of the main PCB 224 and operatively connected to the communication module 146, which is coupled to the rear surface of the main PCB 224 (FIG. 11). The microphone 150, which may also be coupled to the front surface of the main PCB 224, is located near the opening 218 (FIG. 4) in the upper portion 214 of the shield 192 so that sounds emanating from the area around the A/V recording and communication device 130 can pass through the opening 218 and be detected by the microphone 150. With reference to FIG. 13, the speaker chamber 248 is located near the bottom of the enclosure 180. The speaker chamber 248 comprises a hollow enclosure in which the speaker 152 is located. The hollow speaker chamber 248 amplifies the sounds made by the speaker 152 so that they can be better heard by a visitor in the area near the A/V recording and communication device 130. With reference to FIGS. 5 and 13, the lower surface 252 of the shell 184 and the lower surface (not shown) of the enclosure 180 may include an acoustical opening 254 through which the sounds made by the speaker 152 can pass so that they can be better heard by a visitor in the area near the A/V recording and communication device 130. In the illustrated embodiment, the acoustical opening 254 is shaped generally as a rectangle having a length extending substantially across the lower surface 252 of the shell 184 (and also the enclosure 180). The illustrated shape is, however, just one example. With reference to FIG. 5, the lower surface 252 of the shell 184 may further include an opening 256 for receiving a security screw (not shown). The security screw may extend through the opening 256 and into a similarly located opening in the enclosure 180 to secure the shell 184 to the enclosure 180. If the device 130 is mounted to a mounting bracket (not shown), the security screw may also maintain the device 130 on the mounting bracket.

With reference to FIG. 13, the A/V recording and communication device 130 may further include a battery heater 258. The present A/V recording and communication device 130 is configured for outdoor use, including in cold climates. Cold temperatures, however, can cause negative performance issues for rechargeable batteries, such as reduced energy capacity, increased internal resistance, reduced ability to charge without damage, and reduced ability to supply load current. The battery heater 258 helps to keep the rechargeable battery 142 warm in order to reduce or eliminate the foregoing negative performance issues. In the illustrated embodiment, the battery heater 258 comprises a substantially flat, thin sheet abutting a side surface of the rechargeable battery 142. The battery heater 258 may comprise, for example, an electrically resistive heating element that produces heat when electrical current is passed through it. The battery heater 258 may thus be operatively coupled to the power manager 140 and/or the power sequencer 144 (FIG. 12). In some embodiments, the rechargeable battery 142 may include a thermally sensitive resistor (“thermistor,” not shown) operatively connected to the processor 160 so that the battery 142's temperature can be monitored and the amount of power supplied to the battery heater 258 can be adaptively controlled to keep the rechargeable battery 142 within a desired temperature range.

As discussed above, the present disclosure provides numerous examples of methods and systems including A/V recording and communication doorbells, but the present embodiments are equally applicable for A/V recording and communication devices other than doorbells. For example, the present embodiments may include one or more A/V recording and communication security cameras and/or floodlight controllers instead of, or in addition to, one or more A/V recording and communication doorbells. An example A/V recording and communication security camera may include substantially all of the structure and functionality of the device 130, but without the front button 148, the button actuator 228, and/or the light pipe 232. Similar to the security camera, an example of a floodlight controller may include substantially all of the structure and functionality of the device 130, but without the front button 148, the button actuator 228, and/or the light pipe 232, while having additional floodlights that the floodlight controller may turn on and off, for example in response to a detection of motion as described herein.

The present disclosure also provides numerous examples of methods and systems including A/V recording and communication devices that are powered by a connection to AC mains, but the present embodiments are equally applicable for A/V recording and communication devices that are battery powered. For example, the present embodiments may include an A/V recording and communication device such as those described in US Patent Application Publication Nos. 2015/0022620 (application Ser. No. 14/499,828) and 2015/0022618 (application Ser. No. 14/334,922), both of which are incorporated herein by reference in their entireties as if fully set forth.

As discussed above, there is a significant need to identify suspicious persons, and/or suspicious behavior of persons, near a property or a residence using machine vision and/or software, without the substantial intervention of a human user. It would be advantageous, therefore, if the functionality of A/V recording and communication devices, such as A/V doorbells, could be leveraged to identify suspicious person(s) and/or behavior(s), generate alerts, and then transmit those alerts to one or more client devices associated with the A/V recording and communication device associated with that property or residence. The present embodiments provide these advantages and enhancements, as described below.

For example, some of the present embodiments identify suspicious persons, and/or determine that the person is engaged in suspicious behavior, by receiving image data of a person within a field of view of the camera of the A/V recording and communication device, determining, using the image data, whether the person is a suspicious person, upon determining that the person is a suspicious person, generating an alert, and transmitting the alert to a client device associated with the A/V recording and communication device. In various embodiments, these steps can be carried out either entirely within the A/V recording and communication device, or with the use of the A/V recording and communication device and one or more backend processors, one or more databases, and one or more networks enabling communication between the devices that make up the described system.

Some of the present embodiments comprise computer vision for one or more aspects, such as object recognition. Computer vision includes methods for acquiring, processing, analyzing, and understanding images and, in general, high-dimensional data from the real world in order to produce numerical or symbolic information, e.g. in the form of decisions. Computer vision seeks to duplicate the abilities of human vision by electronically perceiving and understanding an image. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory. Computer vision has also been described as the enterprise of automating and integrating a wide range of processes and representations for vision perception. As a scientific discipline, computer vision is concerned with the theory behind artificial systems that extract information from images. The image data can take many forms, such as video sequences, views from multiple cameras, or multi-dimensional data from a scanner. As a technological discipline, computer vision seeks to apply its theories and models for the construction of computer vision systems.

One aspect of computer vision comprises determining whether or not the image data contains some specific object, feature, or activity. Different varieties of computer vision recognition include: Object Recognition (also called object classification)—One or several pre-specified or learned objects or object classes can be recognized, usually together with their 2D positions in the image or 3D poses in the scene. Identification—An individual instance of an object is recognized. Examples include identification of a specific person's face or fingerprint, identification of handwritten digits, or identification of a specific vehicle. Detection—The image data are scanned for a specific condition. Examples include detection of possible abnormal cells or tissues in medical images or detection of a vehicle in an automatic road toll system. Detection based on relatively simple and fast computations is sometimes used for finding smaller regions of interesting image data that can be further analyzed by more computationally demanding techniques to produce a correct interpretation.

Several specialized tasks based on computer vision recognition exist, such as: Optical Character Recognition (OCR)—Identifying characters in images of printed or handwritten text, usually with a view to encoding the text in a format more amenable to editing or indexing (e.g. ASCII). 2D Code Reading—Reading of 2D codes such as data matrix and QR codes. Facial Recognition. Shape Recognition Technology (SRT)—Differentiating human beings (e.g. head and shoulder patterns) from objects.

Typical functions and components (e.g. hardware) found in many computer vision systems are described in the following paragraphs. The present embodiments may include at least some of these aspects. For example, with reference to FIG. 3, embodiments of the present A/V recording and communication device 130 may include a computer vision module 163. The computer vision module 163 may include any of the components (e.g. hardware) and/or functionality described herein with respect to computer vision, including, without limitation, one or more cameras, sensors, and/or processors. In some embodiments, the microphone 150, the camera 154, and/or the imaging processor 240 may be components of the computer vision module 163.

Image acquisition—A digital image is produced by one or several image sensors, which, besides various types of light-sensitive cameras, may include range sensors, tomography devices, radar, ultra-sonic cameras, etc. Depending on the type of sensor, the resulting image data may be a 2D image, a 3D volume, or an image sequence. The pixel values may correspond to light intensity in one or several spectral bands (gray images or color images), but can also be related to various physical measures, such as depth, absorption or reflectance of sonic or electromagnetic waves, or nuclear magnetic resonance.

Pre-processing—Before a computer vision method can be applied to image data in order to extract some specific piece of information, it is usually beneficial to process the data in order to assure that it satisfies certain assumptions implied by the method. Examples of pre-processing include, but are not limited to re-sampling in order to assure that the image coordinate system is correct, noise reduction in order to assure that sensor noise does not introduce false information, contrast enhancement to assure that relevant information can be detected, and scale space representation to enhance image structures at locally appropriate scales.

Feature extraction—Image features at various levels of complexity are extracted from the image data. Typical examples of such features are: Lines, edges, and ridges; Localized interest points such as corners, blobs, or points; More complex features may be related to texture, shape, or motion.

Detection/segmentation—At some point in the processing a decision may be made about which image points or regions of the image are relevant for further processing. Examples are: Selection of a specific set of interest points; Segmentation of one or multiple image regions that contain a specific object of interest; Segmentation of the image into nested scene architecture comprising foreground, object groups, single objects, or salient object parts (also referred to as spatial-taxon scene hierarchy).

High-level processing—At this step, the input may be a small set of data, for example a set of points or an image region that is assumed to contain a specific object. The remaining processing may comprise, for example: Verification that the data satisfy model-based and application-specific assumptions; Estimation of application-specific parameters, such as object pose or object size; Image recognition—classifying a detected object into different categories; Image registration—comparing and combining two different views of the same object.

Decision making—Making the final decision required for the application, for example match/no-match in recognition applications.

One or more of the present embodiments may include a vision processing unit (not shown separately, but may be a component of the computer vision module 163). A vision processing unit is an emerging class of microprocessor; it is a specific type of AI (artificial intelligence) accelerator designed to accelerate machine vision tasks. Vision processing units are distinct from video processing units (which are specialized for video encoding and decoding) in their suitability for running machine vision algorithms such as convolutional neural networks, SIFT, etc. Vision processing units may include direct interfaces to take data from cameras (bypassing any off-chip buffers), and may have a greater emphasis on on-chip dataflow between many parallel execution units with scratchpad memory, like a manycore DSP (digital signal processor). But, like video processing units, vision processing units may have a focus on low precision fixed point arithmetic for image processing.

Some of the present embodiments may use facial recognition hardware and/or software, as a part of the computer vision system. Various types of facial recognition exist, some or all of which may be used in the present embodiments.

Some face recognition algorithms identify facial features by extracting landmarks, or features, from an image of the subject's face. For example, an algorithm may analyze the relative position, size, and/or shape of the eyes, nose, cheekbones, and jaw. These features are then used to search for other images with matching features. Other algorithms normalize a gallery of face images and then compress the face data, only saving the data in the image that is useful for face recognition. A probe image is then compared with the face data. One of the earliest successful systems is based on template matching techniques applied to a set of salient facial features, providing a sort of compressed face representation.

Recognition algorithms can be divided into two main approaches, geometric, which looks at distinguishing features, or photometric, which is a statistical approach that distills an image into values and compares the values with templates to eliminate variances.

Popular recognition algorithms include principal component analysis using eigenfaces, linear discriminant analysis, elastic bunch graph matching using the Fisherface algorithm, the hidden Markov model, the multilinear subspace learning using tensor representation, and the neuronal motivated dynamic link matching.

Further, a newly emerging trend, claimed to achieve improved accuracy, is three-dimensional face recognition. This technique uses 3D sensors to capture information about the shape of a face. This information is then used to identify distinctive features on the surface of a face, such as the contour of the eye sockets, nose, and chin.

One advantage of 3D face recognition is that it is not affected by changes in lighting like other techniques. It can also identify a face from a range of viewing angles, including a profile view. Three-dimensional data points from a face vastly improve the precision of face recognition. 3D research is enhanced by the development of sophisticated sensors that do a better job of capturing 3D face imagery. The sensors work by projecting structured light onto the face. Up to a dozen or more of these image sensors can be placed on the same CMOS chip—each sensor captures a different part of the spectrum.

Another variation is to capture a 3D picture by using three tracking cameras that point at different angles; one camera pointing at the front of the subject, a second one to the side, and a third one at an angle. All these cameras work together to track a subject's face in real time and be able to face detect and recognize.

Another emerging trend uses the visual details of the skin, as captured in standard digital or scanned images. This technique, called skin texture analysis, turns the unique lines, patterns, and spots apparent in a person's skin into a mathematical space.

Another form of taking input data for face recognition is by using thermal cameras, which may only detect the shape of the head and ignore the subject accessories such as glasses, hats, or make up.

Further examples of automatic identification and data capture (AIDC) and/or computer vision that can be used in the present embodiments to verify the identity and/or authorization of a person include, without limitation, biometrics. Biometrics refers to metrics related to human characteristics. Biometrics authentication (or realistic authentication) is used in various forms of identification and access control. Biometric identifiers are the distinctive, measurable characteristics used to label and describe individuals. Biometric identifiers can be physiological characteristics and/or behavioral characteristics. Physiological characteristics may be related to the shape of the body. Examples include, but are not limited to, fingerprints, palm veins, facial recognition, three-dimensional facial recognition, skin texture analysis, DNA, palm prints, hand geometry, iris recognition, retina recognition, and odor/scent recognition. Behavioral characteristics may be related to the pattern of behavior of a person, including, but not limited to, typing rhythm, gait, and voice recognition.

The present embodiments may use any one, or any combination of more than one, of the foregoing biometrics to identify and/or authenticate a person who is either suspicious or who is authorized to take certain actions with respect to a property or expensive item of collateral. For example, the computer vision module 163, and/or the camera 154 and/or the controller/processor 160 may receive information about the person using any one, or any combination of more than one, of the foregoing biometrics.

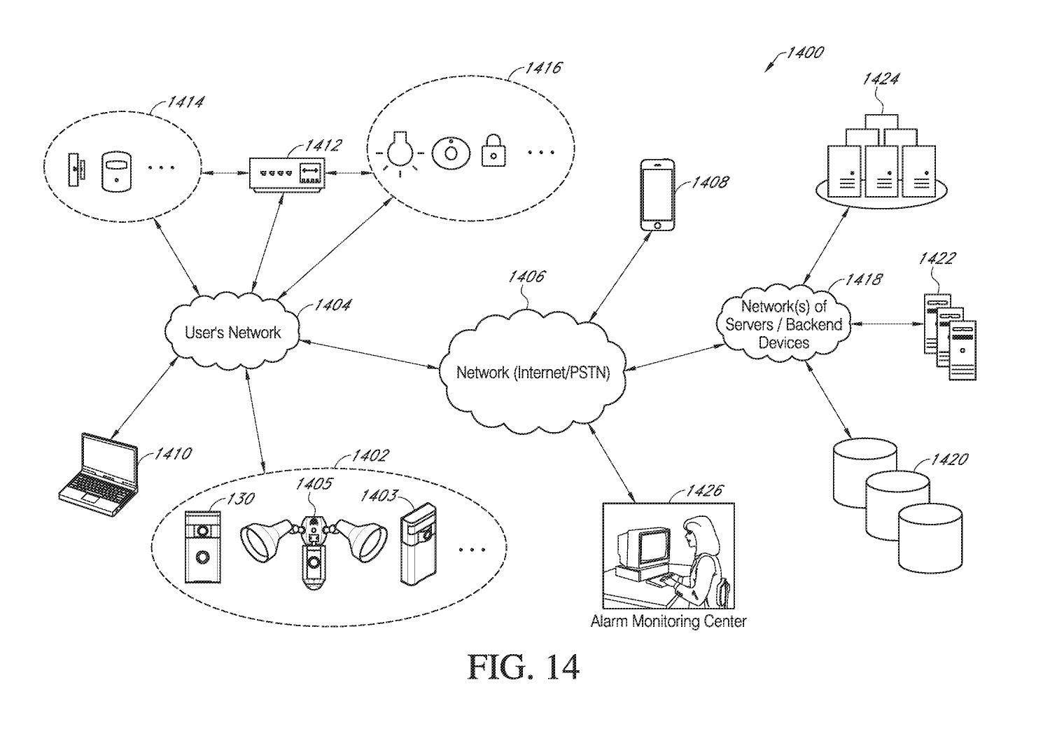

FIG. 14 is a functional block diagram illustrating a system 1400 for communicating in a network according to various aspects of the present disclosure. The system 1400 may include one or more A/V recording and communication devices 1402 configured to access (e.g., connect to) a user's network 1404 (which may correspond to the user's network 140) to connect to a network (Internet/PSTN) 1406 (in some embodiments, the devices 1402 may be configured to connect directly to the network (Internet/PSTN) 1406, such as over a cellular connection). The one or more A/V recording and communication devices 1402 may include any or all of the components and/or functionality of the A/V recording and communication devices 100 and/or 130 (FIGS. 1-3). The one or more A/V recording and communication devices 1402 may also include a floodlight controller 1405 and a security camera 1403, as previously described.

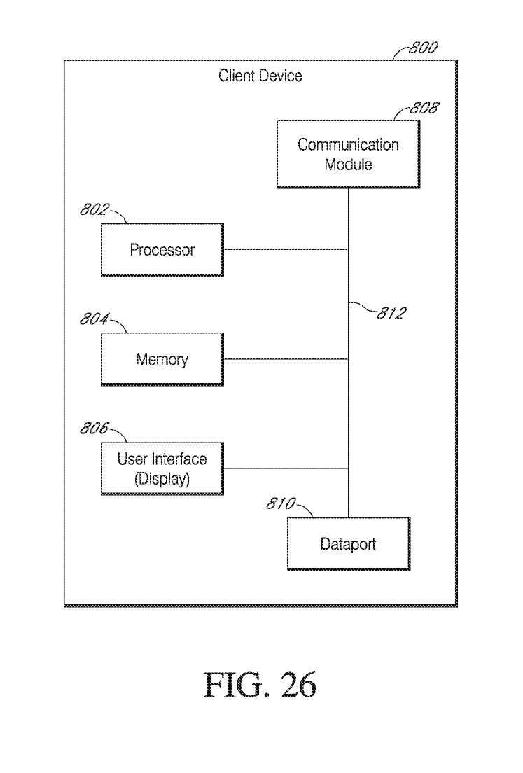

The user's network 1404 may include any or all of the components and/or functionality of the user's network 110 described herein. The system 1400 may also include one or more client devices 1408, 1410, which in various embodiments may be configured to be in network communication and/or associated with the A/V recording and communication device 1402. In one embodiment, the client devices 1408, 1410 may be associated with the A/V recording and communication device through a user account that is created by the user upon an initial setup of the A/V recording and communication device. The client devices 1408, 1410 may comprise, for example, a mobile phone such as a smartphone, or a computing device such as a tablet computer, a laptop computer, a desktop computer, etc. The client devices 1408, 1410 may include any or all of the components and/or functionality of the client device 114 (FIG. 1) and/or the client device 800 (FIG. 26) described herein. In some embodiments, one or more of the client devices 1408, 1410 may not be associated with the A/V recording and communication device 1402.

The system 1400 may further include a smart-home hub device 1412 (which may alternatively be referred to herein as the hub device 1412) connected to the user's network 1404. The smart-home hub device 1412 (also known as a home automation hub, a premises security hub, gateway device, etc.), may comprise any device that facilitates communication with and control of the sensors 1414, automation devices 1416, and/or the one or more A/V recording and communication devices 1402. For example, the smart-home hub device 1412 may be a component of a home automation system installed at a property. In some embodiments, the A/V recording and communication devices 1402, the sensors 1414, and/or the automation devices 1416 may communicate with the smart-home hub device 1412 directly and/or indirectly via the user's network 1404 and/or the network (Internet/PSTN) 1406. In some of the present embodiments, the A/V recording and communication devices 1402, the sensors 1414, and/or the automation devices 1416 may, in addition to or in lieu of communicating with the smart-home hub device 1412, communicate with the client devices 1408, 1410 and/or one or more of the components of the network of servers/backend devices 1418 directly and/or indirectly via the user's network 1404 and/or the network (Internet/PSTN) 1406.

Home automation, or smart home, is building automation for the home. It involves the control and automation of various devices and/or systems, such as lighting, heating (such as smart thermostats), ventilation, air conditioning (HVAC), blinds/shades, and security, as well as home appliances, such as washers/dryers, ovens, or refrigerators/freezers. Wi-Fi is often used for remote monitoring and control. Smart home devices (e.g., the hub device 1412, the sensors 1414, the automation devices 1416, the A/V recording and communication devices 1402, etc.), when remotely monitored and controlled via the network (Internet/PSTN) 1406, may be considered to be components of the Internet of Things. Smart home systems may include switches and/or sensors (e.g., the sensors 1414) connected to a central hub such as the smart-home hub device 1412, sometimes called a gateway, from which the system may be controlled with a user interface. The user interface may include any or all of a wall-mounted terminal (e.g., a keypad, a touchscreen, etc.), software installed on the client devices 1408, 1410 (e.g., a mobile application), a tablet computer or a web interface, often but not always via Internet cloud services. The home automation system may use one or more communication protocols, including either or both of wired and wireless protocols, including but not limited to Wi-Fi, X10, Ethernet, RS-485, 6LoWPAN, Bluetooth LE (BTLE), ZigBee, and Z-Wave.

The one or more sensors 1414 may include, for example, at least one of a door sensor, a window sensor, a contact sensor, a tilt sensor, a temperature sensor, a carbon monoxide sensor, a smoke detector, a light sensor, a glass break sensor, a motion sensor, and/or other sensors that may provide the user/owner of the security system a notification of a security event at his or her property.

The one or more automation devices 1416 may include, for example, at least one of an outdoor lighting system, an indoor lighting system, and indoor/outdoor lighting system, a temperature control system (e.g., a thermostat), a shade/blind control system, a locking control system (e.g., door lock, window lock, etc.), a home entertainment automation system (e.g., TV control, sound system control, etc.), an irrigation control system, and/or other automation devices.

As described herein, in some of the present embodiments, some or all of the user's network 1404, the client devices 1408, 1410, the A/V recording and communication device 1402, the smart-home hub device 1412, the sensors 1414, and the automation devices 1416 may be referred to as a security system, which may be installed at a property or premises.

With further reference to FIG. 14, the system 1400 may also include various backend devices such as (but not limited to) storage devices 1420, backend servers 1422, and backend APIs 1424 that may be in network communication (e.g., over the user's network 1404 and/or the network (Internet/PSTN) 1406) with the A/V recording and communication devices 1402, the hub device 1412, the client devices 1408, 1410, the sensors 1414, and/or the automation devices 1416. In some embodiments, the storage devices 1420 may be a separate device from the backend servers 1422 (as illustrated) or may be an integral component of the backend servers 1422. The storage devices 1420 may be similar in structure and/or function to the storage device 116 (FIG. 1). In addition, in some embodiments, the backend servers 1422 and backend APIs 1424 may be similar in structure and/or function to the server 118 and the backend API 120 (FIG. 1), respectively.

With further reference to FIG. 14, the system 1400 may also include a security monitoring service 1426. The security monitoring service 1426 may be operated by the same company that manufactures, sells, and/or distributes the A/V recording and communication devices 1402, the hub device 1412, the sensors 1414, and/or the automation devices 1416. In other embodiments, the security monitoring service 1426 may be operated by a third-party company (e.g., a different company than the one that manufactured, sold, and/or distributed the A/V recording and communication devices 1402, the hub device 1412, the sensors 1414, and/or the automation devices 1416). In any of the present embodiments, the security monitoring service 1426 may have control of at least some of the features and components of the security system (e.g., the security monitoring service 1426 may be able to arm and/or disarm the security system, lock and/or unlock doors, activate and/or deactivate one or more of the sensors 1414 and/or the automation devices 1416, etc.). For example, the security monitoring service 1426 may operate and control their own client devices and/or network of servers/backend devices for monitoring and/or controlling security systems. In such an example, the A/V recording and communication devices 1402, the hub device 1412, the sensors 1414, and/or the automation devices 1416 may communicate with the client devices and/or one or more components of the network of servers/backend devices of the security monitoring service 1426 over the network (Internet/PSTN) 1406 (in some embodiments, via one or more of the components of the network of backend servers/backend devices 1418).

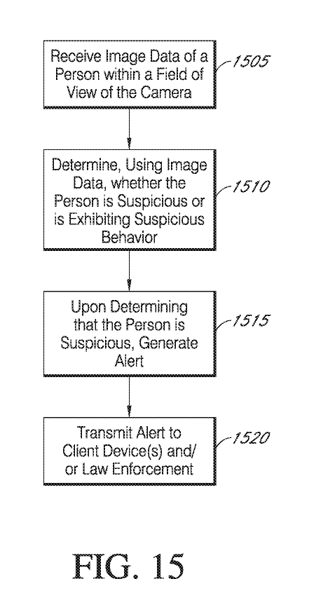

FIG. 15 illustrates an example embodiment of a process for identifying suspicious persons according to various aspects of the present disclosure. At block 1505, the process receives image data of a person within a field of view of the camera of an A/V recording and communication device, such as the A/V recording and communication device 130 described above. At block 1510, the process determines, using the image data, whether the person is a suspicious person, or is exhibiting suspicious behavior. At block 1515, upon determining that the person is a suspicious person, the process generates an alert. At block 1520, the process transmits the alert to a client device associated with the A/V recording and communication device. The present embodiments encompass any method of determining that a person is suspicious or is exhibiting suspicious behavior, and several examples are provided below. The present embodiments are not, however, limited to these examples, which are provided for illustration only. Any of the examples described below, as well as any of the present embodiments, may include one or more aspects of computer vision or a similar technique/technology, whether now known or later developed.

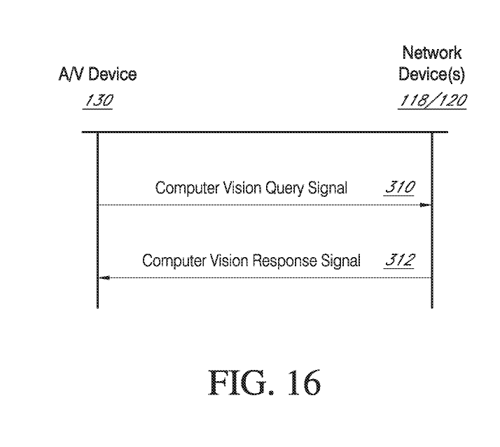

FIG. 16 illustrates a sequence diagram for communications between the A/V device 130 and the network device(s) 118 or 120. This sequence diagram may be applicable to multiple embodiments discussed herein that include any computer vision query and response, as represented by computer vision query signal 310 and computer vision response signal 312.

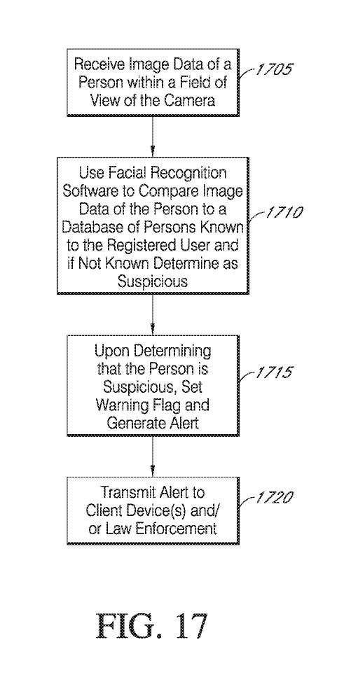

FIG. 17 illustrates a further embodiment of a process for identifying suspicious persons. In this example embodiment, received image data (block 1705) of the person that is in the field of view of the camera 154 of the A/V recording and communication device 130 may be used by facial recognition software to compare facial characteristics or features of the person to a database of persons that are known to the registered user of the A/V recording and communication device, at block 1710. This comparison may be performed using any of the facial recognition algorithms described above, or later developed. Upon a determination that the person in the field of view is not present in the database of known persons, a warning flag may be set, at block 1715, and/or an alert may be generated and sent to a client device associated with the A/V recording and communication device 130, at block 1720. The facial recognition software may also use biometric information, and/or distinguishing facial features or characteristics.

The database of known persons (block 1710) may be resident on the device 130, but more commonly will be located on a server and accessed through an API. The database may contain as much information as possible about each known person, such as their facial features or characteristics, name, aliases, and/or relationship to the registered user. In one embodiment, the database of known persons may be modified by the user, such as through the client device. Specifically, the user may, upon review of stored images of visitors, flag a particular stored image of a visitor as known to the registered user. This image may then be uploaded into the database. Additionally, a user may upload (e.g., save) one or more images of persons that the user knows into the database, from sources other than those captured by the A/V recording and communication device 130, e.g., from the user's smartphone camera. This example embodiment allows for the user to receive alerts about persons that are known and acceptable visitors for the registered user, for example, family members, neighbors, postal workers, or regularly scheduled service providers such as a gardener or newspaper delivery person.

Some embodiments may perform variations of the process of FIG. 17, such as performing different specific operations in different embodiments. For example, rather than identifying suspicious persons upon the determination that a person within the field of view of the camera 154 is not present in the database of known persons, the identification may be based upon the determination that the person is present in a database of known suspicious persons. For instance, the database of known suspicious persons may identify convicted felons and/or registered sex offenders. In some embodiments, the database may also include people that are known to be suspicious to the user, such as an ex-spouse, a hostile co-worker, a hostile neighbor, etc. Thus, upon a determination that the person in the field of view is present in the database of known suspicious persons, a warning flag may be set, at block 1715, and/or an alert may be generated and sent to a client device associated with the A/V recording and communication device 130, at block 1720.

In another embodiment, the process determines if the person that is in the field of view of the camera 154 of the A/V recording and communication device 130 is exhibiting suspicious behavior. This determination can be performed either at the same time as, before, or after the determination is made as to whether the person can be identified as a suspicious person using one or more database searches.

Unfortunately, suspicious behavior comes in many forms. The present embodiments categorize and discuss some known forms of suspicious behavior regarding properties, residences, and expensive items of collateral, e.g., automobiles. However, this discussion should not be taken to be a comprehensive list, and the ability to identify other forms of suspicious behavior, such as by using algorithms similar to those described herein, are contemplated to be within the scope of the present embodiments.

One form of suspicious behavior is loitering. Loitering is often a prelude to a number of property and personal crimes, such as burglary, vandalism, breaking-and-entering, home invasion robbery, etc. Loitering may be identified using the several of the present embodiments in a variety of ways. For example, in one embodiment, the A/V recording and communication device 130 is configured to record and save image data of all persons who enter the field of view of the camera 154 to create saved visitor images. These saved visitor images may then be automatically compared to the images of subsequent visitors within a certain period of time. Then, using the saved visitor images and the image data from a new visitor, if it is determined that the visitor has entered the field of view of the camera more than once within a predetermined period of time, the process may set a suspicious person warning flag and/or generate and send one or more alerts, such as to one or more client devices 114 associated with the A/V recording and communication device 130. This embodiment can be useful to identify a person who approaches a property and enters the field of view of the camera 154, and retreats or briefly leaves, but then returns, such as a person who walks repeatedly back and forth in front of the subject property. In various embodiments, the predetermined period of time can be set by the user, or be preset for a variety of times, such as ten minutes, or twenty-four hours.

Another embodiment identifies loitering as a result of a prolonged presence in the field of view of the camera 154 of the A/V recording and communication device 130. For example, in one embodiment, the A/V recording and communication device 130 is configured to include a timer, or to set a time stamp upon a captured image of a person in the field of view of the camera 154. Then, the device 130, and/or a backend API, calculates the amount of time during which the person remains in the field of view of the camera 154. If this loitering time exceeds a suspicious loitering time warning value, then the process sets a warning flag and/or generates and transmits an alert to the client device. This suspicious loitering time warning value may be preset, or it may be adjustable, including by the owner or user of the A/V recording and communication device 130. Suggested lengths of time for the suspicious loitering time warning value include greater than or equal to two minutes, greater than or equal to five minutes, greater than or equal to seven minutes, greater than or equal to ten minutes and greater than or equal to thirty minutes. However, as will be understood, this amount of time may be set according to the user's needs to any preferred amount of time.

In another embodiment, the process may include the step of determining whether the doorbell of the A/V recording and communication device 130 has been activated. Then, if the doorbell has not been activated, and the suspicious loitering time warning value has been exceeded, the process may set a warning flag and/or generate and transmit an alert to the client device. This embodiment serves to identify loiterers by both the amount of time that they are present, as well as their failure to take an expected action, e.g., ring the doorbell when they are at the front of the property. In each embodiment, the alert may also be transmitted to a public law enforcement agency, a local police department, and/or a private security company.

In another embodiment for identifying suspicious behavior, including loitering, the process employs two distinct A/V recording and communication devices 130. For example, a first A/V recording and communication device 130 is installed at an address, with this first device including a first camera with a first field of view, while a second A/V recording and communication device 130 is installed at the same address, with this second device including a second camera with a second field of view. In some embodiments, the first field of view and the second field of view are not overlapping, so as to provide coverage of a number of different parts of the address at which the devices are installed. For example, but not limitation, the first A/V recording and communication device can be installed at the front door of the property, and the second A/V recording and communication device can be installed at the back door of the property. The process includes determining that a potentially suspicious person has entered the first field of view, and that the same person has left the first field of view and has entered the second field of view. In that event, the process may then set a suspicious person warning flag, and/or generate an alert and transmit the alert to one or more client devices associated with the first and second A/V recording and communication devices 130. This method can advantageously identify suspicious behavior in the form of a person first approaching the front door of a property and then the back door of the same property. It will be understood that this method is not limited to the use of two A/V recording and communication devices 130, but could use as many devices as the property owner wants to install, to provide adequate coverage of multiple entry points, gates, walkways, sheds or outbuildings, fence lines, etc.

In another embodiment of this process, the two A/V recording and communication devices 130 may be installed at different, but nearby, properties. This embodiment can be useful for protecting multiple properties, or even an entire neighborhood, by identifying a person who is engaging in suspicious behavior with respect to a broader area, such as a neighborhood. For example, the process can be used to collect images and/or information about persons visiting neighboring properties, to identify a person who may be surveying an entire neighborhood in order to select one or more houses to rob. The allowable distance between the two different A/V recording and communication devices may be set by either the user(s), or by a system administrator via a backend server. This allowable distance may be any reasonable distance in view of the features and characteristics of the area (e.g., a neighborhood), but may be, for example, 100 feet apart, 300 feet apart, 500 feet apart, a half-mile apart, a mile apart, or more. This same process can be practiced with respect to more than two A/V recording and communication devices 130, such as three or more devices in a neighborhood where multiple homeowners have such devices installed. In each instance of this process, an alert may be sent to the client device(s) of each of the users of the respective A/V recording and communication devices 130 used by the system to identify suspicious behavior. Alternatively, an alert can be sent to the client devices of all users of an A/V recording and communication device within a certain geographic area, e.g., a neighborhood alert.

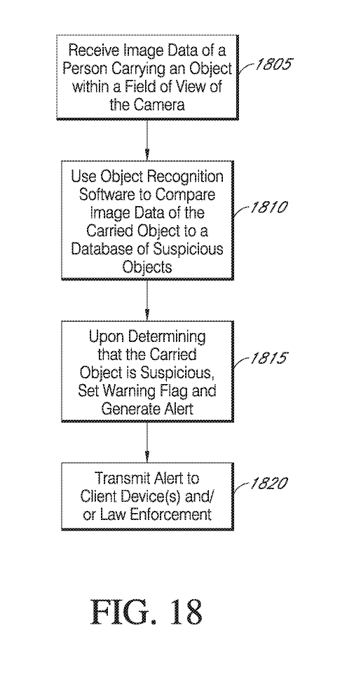

Another form of suspicious behavior is carrying a suspicious object. The present embodiments also contemplate numerous methodologies for determining whether an object that is in the possession of a person who is present within the camera's field of view is a suspicious object (or item), such as a weapon or burglary tool, an embodiment of which is illustrated in FIG. 18. Any or all of these methodologies may include one or more aspects of computer vision, as previously described. For example, in some embodiments, received image data (block 1805) of an object carried by a person within the camera's field of view may be determined to be a suspicious object by using computer vision (or the like) software to compare images received by a camera 154 of an A/V recording and communication device 130 to a database of images of weapons or other types of suspicious objects, at block 1810. In some embodiments, the computer vision software identifies suspicious objects by identifying objects that are similar to, but not an exact match for, known suspicious objects that are in the database. Images of known suspicious objects within the database may include firearms, knives, clubs, including baseball bats and golf clubs not stored in a golf bag, and burglary tools or tools known to be used in burglaries, such as crowbars. It will be understood that the database can be populated to include may other suspicious objects and/or weapons, and this list is not exhaustive. Upon determining that the person is carrying a suspicious object, a suspicious person warning flag is set, at block 1815, and an alert is generated and transmitted at block 1820. The alert may be sent to one or more client devices associated with the A/V recording and communication device 130, and/or to a law enforcement agency, local police department, private security agency, etc.

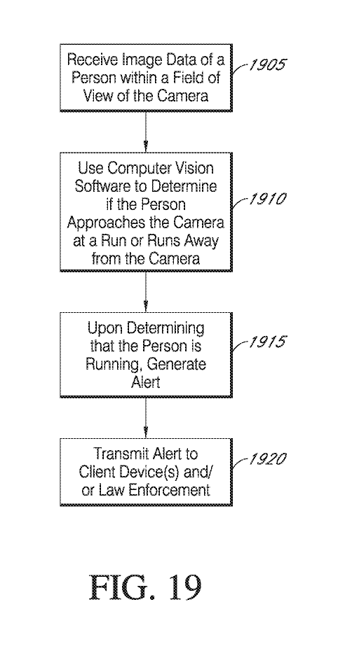

Another form of suspicious behavior is the “door dash.” Sometimes, a potential burglar, thief, or vandal will rapidly approach the exterior of a house, such as the front door, with criminal intent. This is sometimes, for example, the case when a Halloween vandal intends to “egg” a front door or window. Other times, a potential burglar, thief, or vandal will approach the exterior of a house at normal walk, but upon seeing an A/V recording and communication device, will run away from the home. With respect to FIG. 19, a method for recognizing the “door dash” as suspicious behavior is provided. For example, in some embodiments received image data (block 1905) of a person within the camera's field of view may be determined to be suspicious by using computer vision (or the like) software to determine if the person in the field of view of a camera 154 of an A/V recording and communication device 130 is approaching the camera 154 at a run, or is running away from the camera 154, at block 1910. Upon determining that a person is running, a suspicious person warning flag is set, at block 1915, and an alert is generated and transmitted at block 1920. The alert may be sent to one or more client devices associated with the A/V recording and communication device 130, and/or to a law enforcement agency, local police department, private security agency, etc.

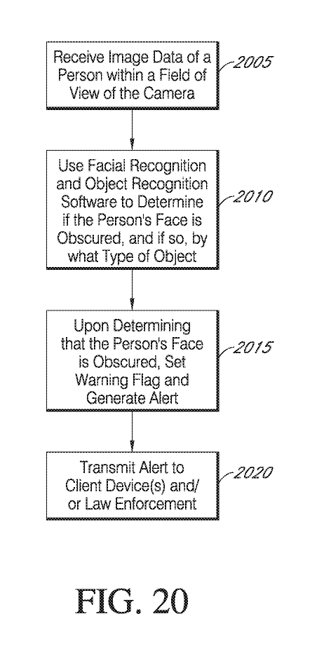

Another form of suspicious behavior is intentionally obscuring, or partially obscuring, a visitor's face, so that it cannot be seen or recognized, either by the camera 154 of the A/V recording and communication device 130, or by a property owner or resident looking through a peephole or window. In embodiments of the present methods, such as that illustrated in FIG. 20, the facial recognition software and the object recognition software can be used to interact with one another, or to act alone, in order to determine, based on received image data (block 2005) of a person within the field of view of a camera 154 of an A/V recording and communication device 130, that the person has used an object to obscure or partially obscure their face, at block 2010. Such obscuring items may include items that are immediately suspicious, such as a ski mask, or items that may be innocent looking, such as a large bouquet of flowers, balloons, or a large package. Other items that may be suspicious, depending upon the circumstances, are a hooded sweatshirt covering a person's head or face on warm days, or the wearing of sunglasses at night. In any event, in accordance with the present embodiments, if the process determines that a person is in the field of view of the camera, but that the person's face is obscured, or is obscured for some predetermined period of time, or that the person's face is obscured at the time that the person activates the doorbell, a suspicious person warning flag may be set, at block 2015, and an alert may be generated and transmitted, at block 2020. The alert may be sent to one or more client devices associated with the A/V recording and communication device 130, and/or to a law enforcement agency, local police department, private security agency, etc.

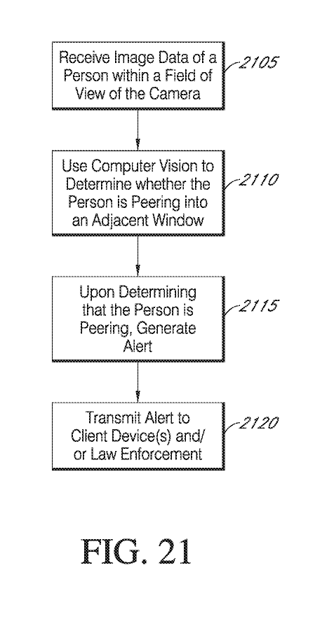

Another form of suspicious behavior is peering into a window. While such behavior may be innocent, it could also indicate criminal intent, such as when a burglar is trying to determine whether a home owner is at home and/or what goods may be present in the home. This method is particularly useful when the A/V recording and communication device is mounted in such a way that it is either adjacent to an exterior window, or has an exterior window within its field of view. As illustrated in FIG. 21, in one embodiment, a process for identifying peering involves receiving image data of a person within a field of view of the camera 154 at block 2105. Next, at block 2110, this image data is analyzed using computer vision (or the like) software to determine if the person is peering into the window. Upon determining that the person is peering, at block 2115, an alert is generated and, at block 2120, that alert is transmitted to a client device and/or law enforcement.

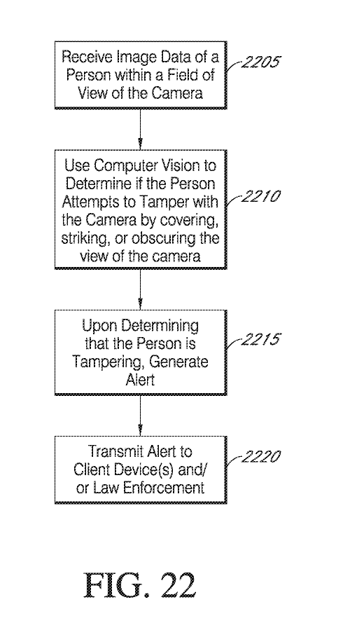

Another form of suspicious behavior is tampering with the camera 154. Forms of tampering are extensive, but generally fall into the categories of covering/obscuring the camera lens, damaging the camera, or removing the camera. With respect to FIG. 22, in one embodiment, a process for identifying this behavior involves receiving image data of a person within a field of view of the camera 154 at block 2205. Next, at block 2210, this image data is analyzed using computer vision (or the like) software to determine if the person is attempting to tamper with the camera by covering, striking, removing, or otherwise obscuring the view of the camera 154. Upon determining that the person is tampering, at block 2215, an alert is generated and, at block 2220, that alert is transmitted to a client device and/or law enforcement.

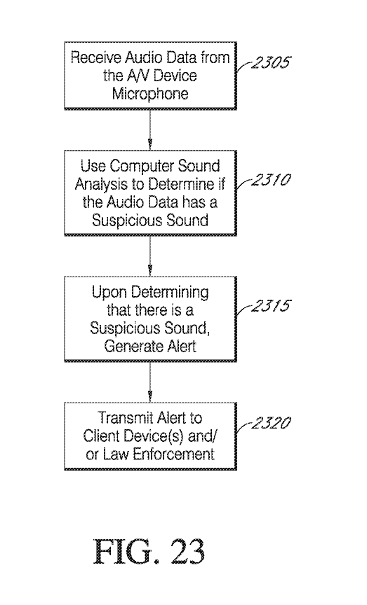

Other forms of suspicious behavior can be ascertained by sound, either instead of, or in addition to, image data. As described above, the A/V recording and communication device 130 includes a microphone 104, 150. This microphone can collect audio data for computer audio analysis, to determine if any suspicious sound has been heard, such as, for example, the sound of glass breaking, wood breaking, screams or yells, an impact of something or someone striking the exterior of a house, or a car crash. With reference to FIG. 23, in one embodiment, a process for identifying this behavior involves receiving audio data from the microphone 150 at block 2305. Next, at block 2310, this audio data is analyzed using computer sound analysis to determine if it is a suspicious sound. Upon determining that the sound is suspicious, at block 2315, an alert is generated and, at block 2320, that alert is transmitted to a client device and/or law enforcement.

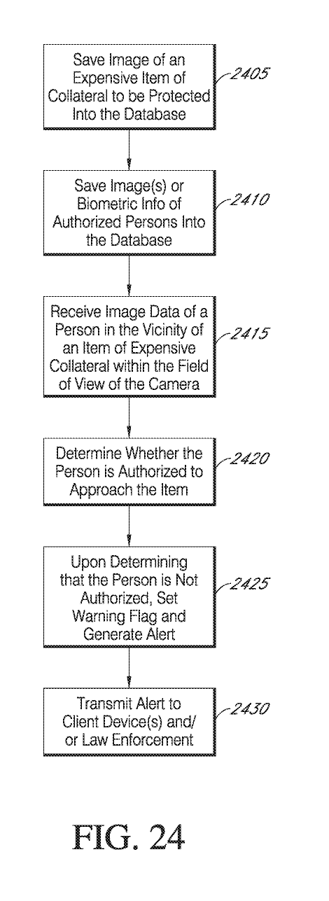

Another form of suspicious behavior is surveying a property or an expensive item of collateral. In embodiments of the present methods, the facial recognition software and the object recognition software can be used to interact with one another, or to act alone, in order to determine that a person has approached an expensive item of collateral, such as an automobile, a tractor or other heavy equipment, expensive power tools, outdoor artwork, etc., and that the person who has approached that expensive item of collateral is not authorized to do so. This embodiment of the process can thus identify persons who may be intent on stealing, damaging, or vandalizing the expensive item of collateral. As illustrated in FIG. 24, in one embodiment, the process involves saving image data of the expensive item of collateral into a database at block 2405, saving image data of authorized persons into a database and marking them as such at block 2410, then determining when the expensive piece of collateral is in the field of view of the camera 154, determining that the person has approached the expensive item of collateral at block 2415, comparing the person's biometric information to the information of all authorized users of the expensive item of collateral at block 2420, and if the person in the field of view is not authorized, setting a suspicious person warning flag and generating an alert at block 2425, and then transmitting the alert at block 2430. The alert may be transmitted to one or more client devices associated with the A/V recording and communication device 130, and/or to a law enforcement agency, local police department, private security agency, etc.

In an embodiment of this method, software may be used to determine whether the distance between the person and the expensive item of collateral is equal to or less than a threshold distance, in order to determine if the person has approached the item too closely. This threshold distance can either be preset or set by the user. In another embodiment, software may be used to determine whether the person has walked completely around the expensive item of collateral, which may suggest that the item is being examined or surveyed by a thief or vandal.

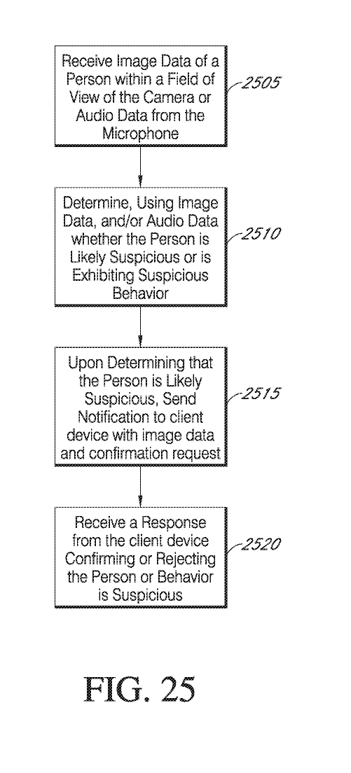

In some instances, it can be useful to have the registered user of the A/V recording and communication device assess and provide feedback on what persons and/or what behavior is—or is not—suspicious. With respect to FIG. 25, in one embodiment, a process for obtaining such feedback involves receiving image data from the camera 154 and/or audio data from the microphone 150 at block 2505. Next, at block 2510, this image data and/or audio data is analyzed using computer vision (or the like) and/or computer sound analysis (or the like) to determine if the person or behavior is likely suspicious. Upon determining that the person or behavior is likely suspicious, at block 2515, a notification is generated and sent to the registered user's client device, along with the image data and/or audio data. This notification also includes a request that the user confirm that the person or behavior is suspicious, or rejecting it as innocent. At block 2520, the registered user's response is transmitted from the client device and received for further processing.

As described above, information processing in the present embodiments may be performed entirely by the A/V recording and communication device 130, entirely by one or more backend devices, or by a combination of the A/V recording and communication device 130 and one or more backend devices. Thus, with reference to FIG. 16, information received by the computer vision module 163 of the A/V recording and communication device 130 may be sent to one or more network devices, such as the server 118 and/or the backend API 120, in a computer vision query signal 310. The one or more network devices may then analyze the sent information and/or compare the sent information with other information in one or more databases to determine whether there is a match, for example in order to identify a person. In one example embodiment, comparing the sent information about the person with other information in one or more databases to determine whether there is a match may comprise comparing the sent information, such as one or more photos or images, about the person with photos and/or images of known suspicious persons. If there is a match, then one or more actions may occur, such as the A/V recording and communication device 130 transitioning to a different operational mode. For example, the network device, such as the server 118 and/or the backend API 120, may send a computer vision response signal 312 to the A/V recording and communication device 130. The computer vision response signal 312 may include a command to the A/V recording and communication device 130 to change the operational mode of the A/V recording and communication device 130. For example, the command to the A/V recording and communication device 130 may cause the A/V recording and communication device 130 to transition to an “armed” mode in which the A/V recording and communication device 130 is configured to take one or more actions when the person is identified, as described herein.

In some embodiments, a crime(s) and/or suspicious event(s) may have been recorded by the A/V recording and communication device 130. For example, a first user of a wireless A/V recording and communication device may view video footage that was recorded by his or her device and determine that the person or persons in the video footage are, or may be, engaged in suspicious activity and/or criminal activity. The first user may then share that video footage with one or more other people, such as other users of wireless A/V recording and communication devices, and/or one or more organizations, including one or more law enforcement agencies. The present embodiments may leverage this shared video footage for use in comparing with the information in the computer vision query signal 310 to determine whether a person detected in the area about the wireless A/V recording and communication device 130 is the same person that was the subject of (and/or depicted in) the shared video footage. If a person detected in the area about the wireless A/V recording and communication device 130 is the same person that was reported in connection with one or more crimes and/or suspicious events, then that person is probably not a person who should be in the area about the wireless A/V recording and communication device 130. In some embodiments, the person (or persons) depicted in the shared video footage may be a perpetrator(s) of one or more other suspicious actions. Further description of sharing video footage from wireless A/V recording and communication devices is provided in US patent application Ser. No. 62/288,971 (filed on Jan. 29, 2016 and entitled “SHARING VIDEO FOOTAGE FROM WIRELESS AUDIO/VIDEO RECORDING AND COMMUNICATION DEVICES”) and 62/300,547 (filed on Feb. 26, 2016 and entitled “SHARING VIDEO FOOTAGE FROM WIRELESS AUDIO/VIDEO RECORDING AND COMMUNICATION DEVICES”), both of which are incorporated herein by reference in their entireties as if fully set forth.

With further reference to FIG. 16, the network device, such as the server 118 and/or the backend API 120, may send the computer vision response signal 312 to the A/V recording and communication device 130. In some embodiments, the computer vision response signal 312 may be sent after a comparison has been made between the information in the computer vision query signal 310 and the information about one or more persons who are in the field of vision of the camera 154 of the A/V recording and communication device 130 and/or the information about one or more persons who have been reported in connection with one or more crimes and/or suspicious events. The computer vision response signal 312 may comprise an indicator (and/or information) about whether a person detected in the area about the A/V recording and communication device 130 is a suspicious person or is engaged in suspicious activity as set forth above.

As described with reference to various embodiments herein, when a person is determined to be suspicious or engaged in suspicious behavior, the process may generate an alert. In some embodiments, the alert may comprise an alert signal sent to a client device. For example, the alert may be similar to, or the same as, the process described above with respect to block B268 of FIG. 2, in which audio and/or video data is transmitted (streamed) from the A/V recording and communication device 130 to the user's client device 114 via the user's network 110 and the network 112. The streaming video may include images of the person(s) who was/were determined to have been unauthorized. The user can then determine whether to take further action, such as alerting law enforcement and/or sharing the video footage with other people, such as via social media.

In some embodiments, the alert may comprise an audible alarm emitted from the speaker 152 of the A/V recording and communication device 130. The audible alarm may be any loud noise likely to attract attention and/or startle the suspicious person, making it more likely that he or she will flee without engaging in further suspicious or criminal behavior. In some embodiments, the alert may comprise an announcement emitted from the speaker 152 of the A/V recording and communication device 130. The announcement may comprise a verbal warning that the area about the A/V recording and communication device 130 is being recorded. The suspicious person, upon being informed that the area about the A/V recording and communication device 130 is being recorded, may decide to flee the scene. In some embodiments, the alert may comprise both an audible alarm and an announcement in combination. Also in some embodiments, the alert may comprise any combination of an alert signal sent to a client device, an audible alarm emitted from the speaker 152 of the A/V recording and communication device 130, and an announcement emitted from the speaker 152 of the A/V recording and communication device 130.

In any of the present embodiments, various aspects of methods may be performed locally, e.g. by one or more components of the A/V recording and communication device 130, and/or remotely, e.g. by one or more network devices, such as the server 118 and/or the backend API 120, for example. For example, the processor 160 of the A/V recording and communication device 130 may perform various aspects such as, but not limited to, comparing video frames recorded by the camera 154 of the A/V recording and communication device 130 to determine whether a person is suspicious or is engaging in suspicious behavior.

Many of the present embodiments have been described with reference to persons detected by, or present in the area about, the A/V recording and communication device 130. The present embodiments are not limited, however, to scenarios involving humans. For example, the present embodiments contemplate that suspicious behavior may be committed by a bot or drone. In some instances, the mere presence of a bot or drone will be identified as suspicious, in other instances, loitering by a drone will be identified as suspicious.

FIG. 26 is a functional block diagram of a client device 800 on which the present embodiments may be implemented according to various aspects of the present disclosure. The user's client device 114 described with reference to FIG. 1 may include some or all of the components and/or functionality of the client device 800. The client device 800 may comprise, for example, a smartphone.

With reference to FIG. 26, the client device 800 includes a processor 802, a memory 804, a user interface 806, a communication module 808, and a dataport 810. These components are communicatively coupled together by an interconnect bus 812. The processor 802 may include any processor used in smartphones and/or portable computing devices, such as an ARM processor (a processor based on the RISC (reduced instruction set computer) architecture developed by Advanced RISC Machines (ARM).). In some embodiments, the processor 802 may include one or more other processors, such as one or more conventional microprocessors, and/or one or more supplementary co-processors, such as math co-processors.

The memory 804 may include both operating memory, such as random access memory (RAM), as well as data storage, such as read-only memory (ROM), hard drives, flash memory, or any other suitable memory/storage element. The memory 804 may include removable memory elements, such as a CompactFlash card, a MultiMediaCard (MMC), and/or a Secure Digital (SD) card. In some embodiments, the memory 804 may comprise a combination of magnetic, optical, and/or semiconductor memory, and may include, for example, RAM, ROM, flash drive, and/or a hard disk or drive. The processor 802 and the memory 804 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 802 may be connected to the memory 804 via the dataport 810.

The user interface 806 may include any user interface or presentation elements suitable for a smartphone and/or a portable computing device, such as a keypad, a display screen, a touchscreen, a microphone, and a speaker. The communication module 808 is configured to handle communication links between the client device 800 and other, external devices or receivers, and to route incoming/outgoing data appropriately. For example, inbound data from the dataport 810 may be routed through the communication module 808 before being directed to the processor 802, and outbound data from the processor 802 may be routed through the communication module 808 before being directed to the dataport 810. The communication module 808 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 810 may be any type of connector used for physically interfacing with a smartphone and/or a portable computing device, such as a mini-USB port or an IPHONE®/IPOD® 30-pin connector or LIGHTNING® connector. In other embodiments, the dataport 810 may include multiple communication channels for simultaneous communication with, for example, other processors, servers, and/or client terminals.

The memory 804 may store instructions for communicating with other systems, such as a computer. The memory 804 may store, for example, a program (e.g., computer program code) adapted to direct the processor 802 in accordance with the present embodiments. The instructions also may include program elements, such as an operating system. While execution of sequences of instructions in the program causes the processor 802 to perform the process steps described herein, hard-wired circuitry may be used in place of, or in combination with, software/firmware instructions for implementation of the processes of the present embodiments. Thus, the present embodiments are not limited to any specific combination of hardware and software.

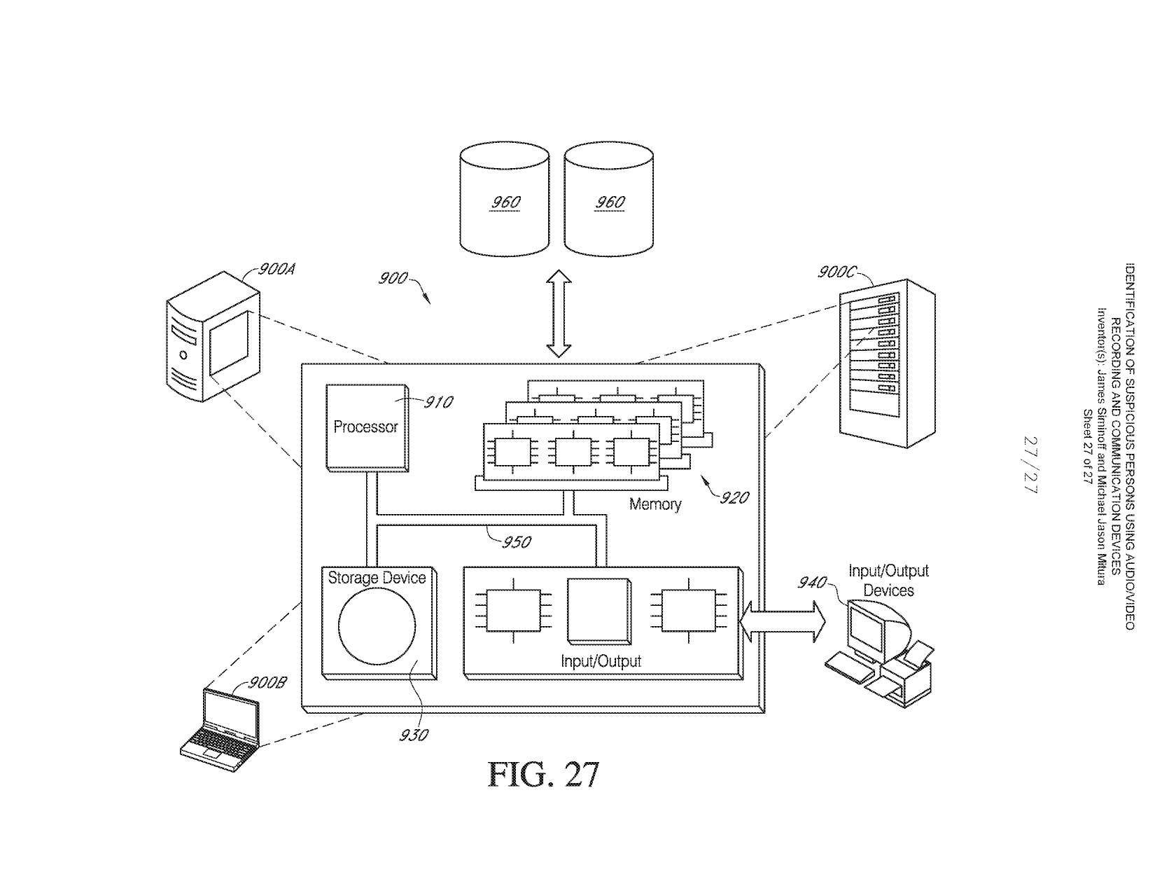

FIG. 27 is a functional block diagram of a general-purpose computing system on which the present embodiments may be implemented according to various aspects of the present disclosure. The computer system 900 may be embodied in at least one of a personal computer (also referred to as a desktop computer) 900A, a portable computer (also referred to as a laptop or notebook computer) 900B, and/or a server 900C. A server is a computer program and/or a machine that waits for requests from other machines or software (clients) and responds to them. A server typically processes data. The purpose of a server is to share data and/or hardware and/or software resources among clients. This architecture is called the client—server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

The computer system 900 may execute at least some of the operations described above. The computer system 900 may include at least one processor 910, memory 920, at least one storage device 930, and input/output (I/O) devices 940. Some or all of the components 910, 920, 930, 940 may be interconnected via a system bus 950. The processor 910 may be single- or multi-threaded and may have one or more cores. The processor 910 may execute instructions, such as those stored in the memory 920 and/or in the storage device 930. Information may be received and output using one or more I/O devices 940.

The memory 920 may store information, and may be a computer-readable medium, such as volatile or non-volatile memory. The storage device(s) 930 may provide storage for the system 900, and may be a computer-readable medium. In various aspects, the storage device(s) 930 may be a flash memory device, a hard disk device, an optical disk device, a tape device, or any other type of storage device.

The I/O devices 940 may provide input/output operations for the system 900. The I/O devices 940 may include a keyboard, a pointing device, and/or a microphone. The I/O devices 940 may further include a display unit for displaying graphical user interfaces, a speaker, and/or a printer. External data may be stored in one or more accessible external databases 960.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

In some embodiments, this disclosure may include the language, for example, “at least one of [element A] and [element B]”. This language may refer to one or more of the elements. For example, “at least one of A and B” may refer to “A”, “B”, or “A and B”. Specifically, “at least one of A and B” may refer to “at least one of A and at least one of B,” or “at least of either A or B.” In some embodiments, this disclosure may include the language, for example, “[element A], [element B], and/or [element C].” This language may refer to either of the elements or any combination thereof. For instance, “A, B, and/or C” may refer to “A”, “B”, “C”, “A and B”, “A and C”, “B and C”, or “A, B, and C”.

What is claimed is:

1. A method for identifying suspicious behavior of a person using a first audio/video (A/V) recording and communication device installed at an address, the first device including a first camera with a first field of view, and a second A/V recording and communication device installed at the address, the second device including a second camera with a second field of view, wherein the first A/V recording and communication device, and the second A/V recording and communication device are each in communication with a processor, and the first field of view and the second field of view are not overlapping, the method comprising:
determining that a person has entered the first field of view;
determining that the person has left the first field of view;
determining that the person has entered the second field of view;
setting a suspicious person warning flag;
generating an alert; and
transmitting the alert to a client device associated with the first and second A/V recording and communication devices.

2. The method of claim 1, wherein the first A/V recording and communication device is installed such that the first field of view includes areas that are publicly accessible and the second A/V recording and communication device is installed such that the second field of view only includes areas that are not publicly accessible.

3. The method of claim 1 further comprising
determining that the person is not in a database of known persons; and
setting the suspicious person warning flag only if the person has entered both the first field of view and the second field of view and is not in the database of known persons.

4. The method of claim 3 further comprising saving an image of a visitor to the database of known persons.

5. The method of claim 4, wherein determining that the person is not in the database of known persons comprises comparing an image of the person captured by at least one of the first camera while the person is in the first field of view and the second camera while the person is in the second field of view, with the image of the visitor to determine whether the person is the visitor.

6. The method of claim 1 further comprising
determining that the person is within the second field of view for at least an amount of time; and
setting the suspicious person warning flag only if the person has entered both the first field of view and the second field of view and is within the second field of view for at least the amount of time.

7. The method of claim 6, wherein the amount of time is five minutes.

8. A method for identifying suspicious behavior of a person using a first audio/video (A/V) recording and communication device installed at a first address, the first device including a first camera with a first field of view, and a second A/V recording and communication device installed at a second address different from the first address, the second device including a second camera with a second field of view, wherein the first A/V recording and communication device and the second A/V recording and communication device are each in communication with a processor, and the first field of view and the second field of view are not overlapping, the method comprising:
determining that a person has entered the first field of view;
determining that the person has left the first field of view;
determining that the person has entered the second field of view;
setting a suspicious person warning flag;
generating an alert; and
transmitting the alert to a client device associated with one of the first and second A/V recording and communication devices.

9. The method of claim 8, wherein the first address and the second address are on a same street.

10. The method of claim 8, wherein the first address and the second address are less than a half-mile apart.

11. The method of claim 8, wherein the first address and the second address are less than one mile apart.

12. The method of claim 8, wherein the client device is a first client device, wherein the method further comprises transmitting the alert to a second client device that is only associated with the first A/V recording and communication device and to a third client device that is only associated with the second A/V recording and communication device.

13. The method of claim 8 further comprising
determining that the person is not in a database of known persons; and
setting the suspicious person warning flag only if the person has entered both the first field of view and the second field of view and is not in the database of known person.

14. The method of claim 13 further comprising saving an image of a visitor to the database of known persons, wherein determining that the person is not in the database of known persons comprises comparing an image of the person captured by at least one of the first camera and the second camera, with the image of the visitor to determine whether the person is the visitor.

15. A method for an audio/video (A/V) recording and communication device, the device including a camera and a doorbell, the method comprising:
receiving image data of a person within a field of view of the camera;
determining, using the image data, whether the person is a suspicious person, wherein said determining comprises:
using computer vision software to analyze the image data to determine if the person approaches the camera at a run; and
using computer vision software to analyze the image data to determine if the person then moves away from the camera at a run;
upon determining that the person is a suspicious person, generating an alert; and
transmitting the alert to a client device associated with the A/V recording and communication device.

16. The method of claim 15, wherein determining whether the person is a suspicious person further comprises
using computer vision software to analyze the image data to identify facial characteristics or features sufficient to distinguish the person;
comparing the facial characteristics or features of the person to facial characteristics or features in a database containing facial characteristics or features of known suspicious persons; and
based on the comparing, determining that the person is either suspicious or not.

17. The method of claim 16 further comprising receiving image data of at least one person known to be suspicious by a user of the A/V recording and communication device; and
saving the image data of the at least one person in the database.

18. The method of claim 15, wherein determining whether the person is a suspicious person further comprises
determining an amount of time in which the person is in the field of view of the camera;
determining if the amount of time exceeds a predetermined period of time; and
if the amount of time is or exceeds the predetermined period of time, setting a suspicious person warning flag to generate the alert.

19. The method of claim of the claim 18, wherein the predetermined period of time is five minutes.

20. The method of claim of claim 15 further comprising transmitting the alert to at least one of a public law enforcement agency and a private security company.
